(19) United States
(12) Patent Application Publication
(10) Pub. No.: US 2012/0085971 A1
(43) Pub. Date: Apr. 12, 2012

(54) Process for Producing Thermally Surface Postcrosslinked Water-Absorbing Polymer Particles

(75) Inventors: Thomas Daniel, Waldsee (DE); Christophe Bauduin, Plankstadt (DE); Andreas Brockmeyer, Alsbach-Hahnlein (DE); Patrick Hamilton, Charlotte, NC (US)

(73) Assignee: BASF SE, Ludwigshafen (DE)

(21) Appl. No.: 13/253,498

(22) Filed: Oct. 5, 2011

Related U.S. Application Data
(60) Provisional application No. 61/390,210, filed on Oct. 6, 2010.

(51) Int. Cl. C09K 3/00; B05D 7/02

(52) U.S. Cl. 252/194; 427/222

(57) ABSTRACT

A process for producing thermally surface postcrosslinked water-absorbing polymer particles, wherein the water-absorbing polymer particles are coated before, during or after the thermal surface postcrosslinking with at least one polyvalent metal salt, and the polyvalent metal salt comprises the anion of glycolic acid or the anion of a glycolic acid derivative.

The present invention relates to a process for producing thermally surface postcrosslinked water-absorbing polymer particles, wherein the water-absorbing polymer particles are coated before, during or after the thermal surface postcrosslinking with at least one polyvalent metal salt, and the polyvalent metal salt comprises the anion of glycolic acid or the anion of a glycolic acid derivative.

Further embodiments of the present invention can be inferred from the claims, the description and the examples. It will be appreciated that the features of the inventive subject matter which have been mentioned above and which are still to be explained below are usable not only in the combination specified in each case, but also in other combinations, without leaving the scope of the invention.

Water-absorbing polymers are especially polymers formed from (co)polymerized hydrophilic monomers, graft (co)polymers of one or more hydrophilic monomers on a suitable graft base, crosslinked cellulose ethers or starch ethers, crosslinked carboxymethylcellulose, partially crosslinked polyalkylene oxide, or natural products swellable in aqueous liquids, for example guar derivatives. Being products which absorb aqueous solutions, such polymers are used to produce diapers, tampons, sanitary napkins and other hygiene articles, but also as water-retaining agents in market gardening. The water-absorbing polymers are often also referred to as “absorbent resins”, “superabsorbents”, “superabsorbent polymers”, “absorbent polymers”, “absorbent gelling materials”, “hydrophilic polymers” or “hydrogels”.

The production of water-absorbing polymers is described in the monograph “Modern Superabsorbent Polymer Technology”, F. L. Buchholz and A. T. Graham, Wiley-VCH, 1998, pages 71 to 103.

To improve the performance properties, for example liquid conductivity in the diaper and absorption capacity under pressure, water-absorbing polymer particles are generally surface postcrosslinked. This surface postcrosslinking can be performed in the aqueous gel phase. Preferably, however, dried, ground and classified polymer particles (base polymer) are coated on the surface with a surface postcrosslinker and thermally surface postcrosslinked. Crosslinkers suitable for this purpose are compounds which comprise at least two groups which can form covalent bonds with the carboxylate groups of the water-absorbing polymer particles.

The determination of the liquid conductivity can be performed, for example, via the saline flow conductivity (SFC) according to EP 0 640 330 A1 or via the gel bed permeability (GBP) according to US 2005/0256757. In addition, combined methods are also customary, which determine a suitable combination of absorption capacity, absorption capacity under pressure, wicking action and liquid conductivity in the diaper, for example the transportation value (TV) described in WO 2006/042704 A1, or the EDANA recommended test method No. WSP 243.1-05 “Permeability Dependent Absorption Under Pressure”. These combination methods are particularly suitable since they give particularly relevant information for diapers which comprise little or no cellulose.

U.S. Pat. No. 5,599,335 discloses that coarser particles have a higher saline flow conductivity (SFC). It is additionally taught that the saline flow conductivity (SFC) can be enhanced by surface postcrosslinking, although the centrifuge retention capacity (CRC) and hence the absorption capacity of the water-absorbing polymer particles always falls.

It is common knowledge to the person skilled in the art that increasing internal crosslinking (more crosslinker in the base polymer) and stronger surface postcrosslinking (more surface postcrosslinker) can enhance saline flow conductivity (SFC) at the expense of centrifuge retention capacity (CRC).

U.S. Pat. No. 4,043,952 discloses the coating of water-absorbing polymer particles with salts of polyvalent cations.

US 2002/128618, US 2004/265387 and WO 2005/080479 A1 disclose coatings with aluminum salts to increase saline flow conductivity (SFC).

WO 2004/069293 A1 discloses water-absorbing polymer particles coated with water-soluble salts of polyvalent cations. The polymer particles have improved saline flow conductivity (SFC) and improved absorption capacities.

WO 2004/069404 A1 discloses salt-resistant water-absorbing polymer particles, each of which have similar values for absorption under a pressure of 49.2 g/cm² (AUL0.7 psi) and centrifuge retention capacity (CRC).

WO 2004/069915 A2 describes a process for producing water-absorbing polymer particles with high saline flow conductivity (SFC), which simultaneously possess strong wicking action, which means that the aqueous liquids can absorb counter to gravity. The wicking action of the polymer particles is achieved by specific surface properties. For this purpose, particles with a size of less than 180 μm are screened out of the base polymer, agglomerated and combined with the previously removed particles larger than 180 μm.

WO 2000/053644 A1, WO 2000/053664 A1, WO 2005/108472 A1 and WO 2008/092843 A1 likewise disclose coatings with polyvalent cations.

WO 2009/041731A1 teaches improving saline flow conductivity (SFC) and centrifuge retention capacity (CRC) by coating with polyvalent cations and fatty acids. Fatty acids, however, also lower the surface tension of the aqueous extract of the water-absorbing polymer particles and hence increase the risk of leakage of the diaper.

US 2010/0247916 discloses the use of basic salts of polyvalent cations, especially for improvement of gel bed permeability (GBP) and absorption under a pressure of 49.2 g/cm² (AUL0.7 psi).

For ultrathin hygiene articles, preferably water-absorbing polymer particles without any coarse grains (particles) are required, since these would be perceptible and can be rejected by consumers. However, it may be necessary for economic reasons to consider the entire diaper construction in the optimization of the particle size distribution of the water-absorbing polymer particles. A coarser particle size distribution can lead to a better ratio of absorption capacity and liquid conductivity in the diaper, but it is typically necessary for this purpose to place a suitable fibrous liquid distribution layer on the absorbent core, or to cover the rough powder with a soft nonwoven at the back too.

The smaller the particles, the lower the saline flow conductivity (SFC). On the other hand, small polymer particles also possess smaller pores which improve liquid transport through their wicking action within the gel layer.

In ultrathin hygiene articles, this plays an important role since they can comprise absorbent cores which consist to an extent of 50 to 100% by weight of water-absorbing polymer particles, such that the polymer particles in use assume both the storage function for the liquid and the function of active (wicking action) and passive liquid transport (liquid conductivity). The more cellulose is replaced by water-absorbing polymer particles or synthetic fibers, the more transport functions have to be fulfilled by the water-absorbing polymer particles in addition to their storage function.

The present invention therefore provides suitable water-absorbing polymer particles for hygiene articles which comprise, in at least part of the absorbent core or in the entire absorbent core, a concentration of water-absorbing polymer particles of at least 50% by weight, preferably at least 60% by weight, more preferably at least 70% by weight, even more preferably at least 80% by weight, most preferably of 90 to 100% by weight. The absorbent core is the part of the hygiene article which serves for the storage and retention of the aqueous body fluid to be absorbed. It typically often consists of a mixture of fibers, for example cellulose, and the water-absorbing polymer particles distributed therein. Optionally, it is also possible to use binders and adhesives to hold the absorbent core together. Alternatively, the water-absorbing polymer particles can also be enclosed in pockets between at least two nonwovens bonded to one another. The other constituents of the hygiene article, including the optional envelope and cover of the absorbent core, are not considered to form part of the absorbent core in the context of this invention.

To produce such water-absorbing polymer particles, coatings of polyvalent cations are typically used. Particularly suitable are aluminum salts (see above), polyamines (disclosed in DE 102 39 074 A1) and water-insoluble phosphates of polyvalent cations such as calcium, zirconium, iron and aluminum (disclosed in WO 2002/060983 A1).

Water-insoluble phosphates have to be applied as a powder. This requires a specific step in the production process, and these powders can disadvantageously become detached again from the surface of the water-absorbing polymer particles, as a result of which the desired properties are lost.

Polyamines typically reduce the absorption capacity under pressure and increase the tackiness of the water-absorbing polymer particles in an often undesirable manner. Especially the increase in the tackiness leads to major processing problems. Moreover, polyamines tend to yellow even in the process for producing the water-absorbing polymer particles, or accelerate the aging thereof, which often leads to discoloration.

The salts of polyvalent metal cations, especially of aluminum, zirconium and iron, are suitable for achieving the desired effects on liquid conductivity, but the success depends on the anion present. When, for example, aluminum sulfate is used, lumps or dust are formed readily even in the course of coating of the water-absorbing polymer particles; moreover, absorption capacity under pressure is reduced. The use of aluminum lactate can likewise lead to dust problems and, moreover, the lactic acid present in free form in the course of coating of the water-absorbing polymer particles is highly corrosive. In addition, the preparation of lactic acid via the customary fermentative processes is expensive and causes a large amount of waste. The lactic acid can also condense to polylactic acid in the course of concentration by removal of water after the coating, which can make the surface of the water-absorbing polymer particles coated therewith undesirably tacky. This can impair the flow properties of the water-absorbing polymer particles.

Other aluminum salts or salts of polyvalent cations with many organic anions either do not act in the desired manner or are sparingly soluble and hence have no advantages over the water-insoluble phosphates described above.

It was therefore an object of the present invention to provide water-absorbing polymer particles with high absorption capacity, high absorption capacity under pressure, high active (wicking action) and passive liquid transport (liquid conductivity), and the water-absorbing polymer particles should especially have a high saline flow conductivity (SFC) and/or a high gel bed permeability (GBP).

It was a further object of the present invention to provide suitable coatings for water-absorbing polymer particles, which are easy to apply, do not have any dusting or tackiness problems and do not lead to excessive corrosion in the process for producing the water-absorbing polymer particles.

It was a further object of the present invention to provide suitable coatings for water-absorbing polymer particles, which are easy to apply from aqueous solution and do not have any use problems owing to sparingly soluble or insoluble salts of polyvalent cations.

It was a further object of the present invention to provide optimized water-absorbing polymer particles with a low mean particle diameter.

It was a further object of the present invention to provide a process for producing water-absorbing polymer particles, wherein white polymer particles free of perceptible odors are obtained, especially when loaded with liquid.

### BRIEF DESCRIPTION OF THE DRAWINGS

FIG. 1 illustrates the test apparatus used in a wicking test to determine the wicking properties of a water-absorbing composite material.

The object is achieved by providing water-absorbing polymer particles comprising

a) at least one polymerized ethylenically unsaturated monomer which bears acid groups and may be at least partly neutralized,

b) at least one polymerized crosslinker,

c) optionally one or more ethylenically unsaturated monomers copolymerized with the monomers mentioned under a),

d) optionally one or more water-soluble polymers and

e) at least one reacted surface postcrosslinker,

said water-absorbing polymer particles having been coated with at least one polyvalent metal salt of the general formula (I)

Mⁿ(X)ₐ(Y)_{c}(OH)_{d} (I)

or with at least two polyvalent metal salts of the general formula (II) and/or of the general formula (III)

Mⁿ(X)ₐ(OH)_{d} (II)

Mⁿ(Y)_{b}(OH)_{d} (III)

in which

M is a polyvalent metal cation of a metal selected from the group of aluminum, zirconium, iron, titanium, zinc, calcium, magnesium and strontium,

n is the valency of the polyvalent metal cation,

a is from 0.1 to n,

b is from 0.1 to n and

c is from 0 to (n -0.1), and

d is from 0 to (n-0.1)

where in the general formula (I) the sum of a, c and d is less than or equal to n, in the general formula (II) a and d is less than or equal to n and in the general formula (III) b and d is less than or equal to n,

X is an acid anion of an acid selected from the group of glycolic acid

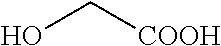

2,2′-oxydiacetic acid (diglycolic acid)

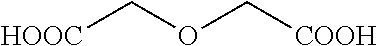

ethoxylated glycolic acids of the general formula (IV)

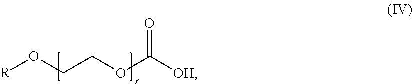

in which

R is H or C₁- to C₁₆-alkyl,

r is an integer from 1 to 30,

such as 3,6-dioxaheptanoic acid

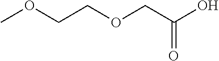

and 3,6,9-trioxadecanoic acid

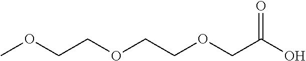

and ethoxylated diglycolic acids of the general formula (V)

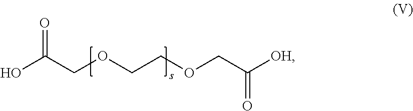

in which

s is an integer from 1 to 30,

and

Y is an acid anion of an acid selected from the group of glyceric acid, citric acid, lactic acid, lactoyllactic acid, malonic acid, hydroxymalonic acid, tartaric acid, glycerol-1,3-diphosphoric acid, glycerolmonophosphoric acid, acetic acid, formic acid, propionic acid, methanesulfonic acid, phosphoric acid and sulfuric acid.

The inventive water-absorbing polymer particles are preferably coated with 0.001 to 0.5% by weight, more preferably 0.005 to 0.2% by weight, most preferably with 0.02 to 0.1% by weight, of the polyvalent metal cation, where the amount of polyvalent metal cation is based on the total amount of polyvalent metal cations in the metal salts of general formula (I) to (III).

In the metal salts of the general formula (I), any mixtures of the acid anions X and Y are possible, but preferably at least 50 mol %, more preferably at least 75 mol %, most preferably at least 90 mol % and a maximum of 100 mol % of the acid anions are selected from the acid anions X.

Preference in the metal salts of the general formula (II) is given in accordance with the invention, however, to acid anions selected only from the acid anions X, particular preference being given to the acid anion of glycolic acid.

The polyvalent metal cations can each be used in the metal salts of general formula (I) to (III) individually, or they can be used in any desired mixtures, preference being given to the cations of aluminum, zirconium, titanium and iron, greater preference to the cations of aluminum and zirconium, and greatest preference to the cation of aluminum.

In one embodiment of the invention, pure aluminum triglycolate is used.

In a further embodiment of the invention, mixtures of aluminum glycolate with at least one further aluminum salt comprising an acid anion Y are used.

In a particularly preferred further embodiment of the invention, mixtures of aluminum salts comprising only acid anions X are used.

A particularly preferred further embodiment of the invention utilizes mixtures of aluminum salts comprising only acid anions Y. Very particular preference is given to mixtures comprising anions of lactic acid and anions of sulfuric acid.

For divalent metal cations (n=2), the number of hydroxide ions (d) is between 0 and (n-0.1), preferably not more than (n-0.5), more preferably not more than (n-1), even more preferably not more than (n-1.3), most preferably not more than (n-1.7).

For trivalent metal cations (n=3), the number of hydroxide ions (d) is between 0 and (n-0.1), preferably not more than (n-0.75), more preferably not more than (n-1.5), even more preferably not more than (n-2), most preferably not more than (n-2.5).

For tetravalent metal cations (n=4), the number of hydroxide ions (d) is between 0 and (n-0.1), preferably not more than (n-1), more preferably not more than (n-2), even more preferably not more than (n-3), most preferably not more than (n-3.5).

The degree of neutralization of the polymerized monomer a) may vary from 0 to 100 mol %, and is typically in the range of 30-90 mol %. In order to achieve the object of the invention, it may, however, be necessary to select the degree of neutralization such that an optimal absorption capacity is combined with good liquid conductivity. Therefore, the acid groups of the polymerized monomer a) have preferably been neutralized to an extent of greater than 45 mol %, more preferably to an extent of greater than 55 mol %, especially preferably to an extent of greater than 65 mol %, very especially preferably to an extent of greater than 68 mol %, and preferably to an extent of at most 80 mol %, more preferably to an extent of at most 76 mol %, especially preferably to an extent of at most 74 mol %, very especially preferably to an extent of at most 72 mol %.

Suitable monomers for the polymerized monomer a), the polymerized crosslinker b) and the polymerized monomer c) are the monomers i), crosslinkers ii) and monomers iii) described below.

Suitable water-soluble polymers for the water-soluble polymers d) are the water-soluble polymers iv) described below.

Suitable surface postcrosslinkers for the reacted surface postcrosslinkers e) are the surface postcrosslinkers v) described below.

The water-absorbing polymer particles typically have a particle size up to at most 1000 μm, the particle size preferably being below 900 μm, preferentially below 850 μm, more preferably below 800 μm, even more preferably below 700 μm, most preferably below 600 μm. The water-absorbing polymer particles have a particle size of at least 50 μm, preferably at least 100 μm, more preferably of at least 150 μm, even more preferably of at least 200 μm, most preferably of at least 300 μm. The particle size can be determined by EDANA recommended test method No. WSP 220.2-05 “Particle Size Distribution”.

Preferably less than 2% by weight, more preferably less than 1.5% by weight, most preferably less than 1% by weight, of the water-absorbing polymer particles have a particle size of less than 150 μm.

Preferably less than 2% by weight, more preferably less than 1.5% by weight, most preferably less than 1% by weight, of the water-absorbing polymer particles have a particle size of more than 850 μm.

Preferably at least 90% by weight, more preferably at least 95% by weight, especially preferably at least 98% by weight, very especially preferably at least 99% by weight, of the water-absorbing polymer particles have a particle size of 150 to 850 μm.

In a preferred embodiment, at least 90% by weight, preferably at least 95% by weight, more preferably at least 98% by weight, most preferably at least 99% by weight, of the water-absorbing polymer particles have a particle size of 150 to 700 μm.

In a further preferred embodiment, at least 90% by weight, preferably at least 95% by weight, more preferably at least 98% by weight, most preferably at least 99% by weight, of the water-absorbing polymer particles have a particle size of 200 to 700 μm.

In a further more preferred embodiment, at least 90% by weight, preferably at least 95% by weight, more preferably at least 98% by weight, most preferably at least 99% by weight, of the water-absorbing polymer particles have a particle size of 150 to 600 μm.

In a further even more preferred embodiment, at least 90% by weight, preferably at least 95% by weight, more preferably at least 98% by weight, most preferably at least 99% by weight, of the water-absorbing polymer particles have a particle size of 200 to 600 p.m.

In a further especially preferred embodiment, at least 90% by weight, preferably at least 95% by weight, more preferably at least 98% by weight, most preferably at least 99% by weight, of the water-absorbing polymer particles have a particle size of 300 to 600 μm.

The water content of the inventive water-absorbing polymer particles is preferably less than 6% by weight, more preferably less than 4% by weight, most preferably less than 3% by weight. Higher water contents are of course also possible, but typically reduce the absorption capacity and are therefore not preferred.

The surface tension of the aqueous extract of the swollen water-absorbing polymer particle at 23° C. is typically at least 0.05 N/m, preferably at least 0.055 N/m, more preferably at least 0.06 N/m, especially preferably at least 0.065 N/m, very especially preferably at least 0.068 N/m.

The centrifuge retention capacity (CRC) of the water-absorbing polymer particles is typically at least 24 g/g, preferably at least 26 g/g, more preferably at least 28 g/g, especially preferably at least 30 g/g, very especially preferably at least 34 g/g, and typically not more than 50 g/g.

The absorption under a pressure of 49.2 g/cm² (AUL0.7 psi) of the water-absorbing polymer particles is typically at least 15 g/g, preferably at least 17 g/g, more preferably at least 20 g/g, especially preferably at least 22 g/g, even more preferably at least 24 g/g, and typically not more than 45 g/g.

The saline flow conductivity (SFC) of the water-absorbing polymer particles is, for example, at least 20×10⁻⁷ cm³s/g, typically at least 40×10⁻⁷ cm³s/g, preferably at least 60×10⁻⁷ cm³s/g, more preferably at least 80×10⁻⁷ cm³s/g, especially preferably at least 100×10⁻⁷ cm³s/g, very especially preferably at least 130×10⁻⁷ cm³s/g, and typically not more than 500×10⁻⁷ cm³s/g.

Preferred inventive water-absorbing polymer particles are polymer particles with the abovementioned properties.

The present invention further provides a process for producing water-absorbing polymer particles by polymerizing a monomer solution or suspension comprising

i) at least one ethylenically unsaturated monomer which bears acid groups and may be at least partly neutralized,

ii) at least one crosslinker,

iii) optionally one or more ethylenically unsaturated monomers copolymerizable with the monomers mentioned under i) and

iv) optionally one or more water-soluble polymers,

and drying, grinding and classifying the resulting polymer gel, coating it with

v) at least one surface postcrosslinker

and thermally surface postcrosslinking it, wherein the water-absorbing polymer particles are coated before, during or after the surface postcrosslinking with at least one polyvalent metal salt of the general formula (I)

Mⁿ(X)ₐ(Y)_{c}(OH)_{d} (I)

or with at least two polyvalent metal salts of the general formula (II) and/or of the general formula (III)

Mⁿ(X)ₐ(OH)_{d} (II)

Mⁿ(Y)_{b}(OH)_{d} (III)

in which

M is a polyvalent metal cation of a metal selected from the group of aluminum, zirconium, iron, titanium, zinc, calcium, magnesium and strontium,

n is the valency of the polyvalent metal cation,

a is from 0.1 to n,

b is from 0.1 to n and

c is from 0 to (n-0.1), and

d is from 0 to (n-0.1)

where in the general formula (I) the sum of a, c and d is less than or equal to n, in the general formula (II) a and d is less than or equal to n and in the general formula (III) b and d is less than or equal to n,

X is an acid anion of an acid selected from the group of glycolic acid

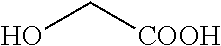

2,2′-oxydiacetic acid (diglycolic acid)

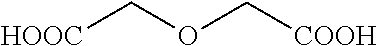

ethoxylated glycolic acids of the general formula (IV)

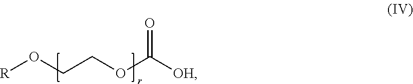

in which

R is H or C₁- to C₁₆-alkyl,

r is an integer from 1 to 30,

such as 3,6-dioxaheptanoic acid

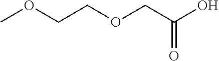

and 3,6,9-trioxadecanoic acid

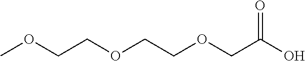

and ethoxylated diglycolic acids of the general formula (V)

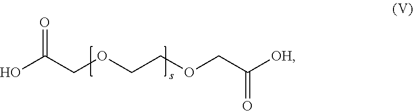

in which

s is an integer from 1 to 30, and

Y is an acid anion of an acid selected from the group of glyceric acid, citric acid, lactic acid, lactoyllactic acid, malonic acid, hydroxymalonic acid, tartaric acid, glycerol-1,3-diphosphoric acid, glycerolmonophosphoric acid, acetic acid, formic acid, propionic acid, methanesulfonic acid, phosphoric acid and sulfuric acid.

In the metal salts of the general formula (I), any mixtures of the acid anions X and Y are possible, but preferably at least 50 mol %, more preferably at least 75 mol %, most preferably at least 90 mol % and a maximum of 100 mol % of the acid anions are selected from the acid anions X.

Preference in the metal salts of the general formula (I) is given in accordance with the invention, however, to acid anions selected only from the acid anions X, particular preference being given to the acid anion of glycolic acid.

The polyvalent metal cations can each be used in the metal salts of general formula (I) to (III) individually, or they can be used in any desired mixtures, preference being given to the cations of aluminum, zirconium, titanium and iron, greater preference to the cations of aluminum and zirconium, and greatest preference to the cation of aluminum.

In one embodiment of the invention, pure aluminum triglycolate is used.

In a further embodiment of the invention, mixtures of aluminum triglycolate with at least one further aluminum salt comprising an acid anion Y are used.

In a particularly preferred further embodiment of the invention, mixtures of aluminum salts comprising only acid anions X are used.

A particularly preferred further embodiment of the invention utilizes mixtures of aluminum salts comprising only acid anions Y. Very particular preference is given to mixtures comprising anions of lactic acid and anions of sulfuric acid.

In a particularly preferred further embodiment of the invention, the water-absorbing polymer particles are coated successively with the at least two polyvalent metal salts of the general formula (II) and/or of the general formula (III), especially before the thermal surface postcrosslinking with at least one polyvalent metal salt of the general formula (II) and/or of the general formula (III) and after the thermal surface postcrosslinking with a further polyvalent metal salt of the general formula (II) and/or of the general formula (III).

For divalent metal cations (n=2), the number of hydroxide ions (d) is between 0 and (n-0.1), preferably not more than (n-0.5), more preferably not more than (n-1), even more preferably not more than (n-1.3), most preferably not more than (n-1.7).

For trivalent metal cations (n=3), the number of hydroxide ions (d) is between 0 and (n-0.1), preferably not more than (n-0.75), more preferably not more than (n-1.5), even more preferably not more than (n-2), most preferably not more than (n-2.5).

For tetravalent metal cations (n=4), the number of hydroxide ions (d) is between 0 and (n-0.1), preferably not more than (n-1), more preferably not more than (n-2), even more preferably not more than (n-3), most preferably not more than (n-3.5).

The polyvalent metal salts of the general formula (I) to (III) can be prepared by reacting a hydroxide, for example aluminum hydroxide or sodium aluminate, with at least one acid, for example glycolic acid. The reaction is effected preferably in aqueous solution or dispersion.

It is likewise possible to react one or more corresponding basic metal salts of the at least one polyvalent metal cation with an acid or an acid mixture, for example glycolic acid and lactic acid, in aqueous solution.

Instead of the hydroxides, it is also possible to use salts with acid anions of comparatively volatile acids, for example aluminum acetate, in which case the comparatively volatile acids can subsequently be removed fully or partly, for example by heating, reduced pressure or stripping the reaction solution with steam, air or inert gas.

Alternatively, it is also possible to select at least two polyvalent metal salts as pure substances, for example aluminum acetate and aluminum triglycolate, to dissolve them together in water, for example while stirring, heating or cooling, and thus to convert them to the dissolved polyvalent metal salt of the general formula (I).

In addition, it is possible to react at least one water- or acid-soluble polyvalent metal salt with at least one further water-soluble salt which provides the desired acid anion and whose cation precipitates with the anion of the at least one water- or acid-soluble metal salt. The precipitate can, for example, be filtered off, such that only the soluble solution content is used. It is equally possible for the precipitate to remain in the aqueous slurry or dispersion, and for it then to be used directly. For example, an aqueous solution of aluminum sulfate or any alum can be reacted with an appropriate desired amount of a glycolate and/or lactate of calcium or strontium, optionally while stirring and cooling or heating, which precipitates insoluble calcium sulfate and leaves the desired aluminum salt in the solution. It is analogously possible to prepare solutions of other polyvalent metal salts of the general formula (I) to (III).

It is equally possible to prepare the at least one polyvalent metal salt of the general formula (I) to (III) by dissolving the elemental metal, for example in powder form, in the desired acid or mixtures thereof. This can be accomplished in concentrated acid or in aqueous solution. Especially in the presence of highly corrosive acids such as lactic acid, this is a possible synthesis route.

Processes for preparing stable aqueous solutions of aluminum and zirconium salts are specified in U.S. Pat. No. 5,233,065, U.S. Pat. No. 5,268,030 and U.S. Pat. No. 5,466,846. These can also be used in analogous form for the preparation of the polyvalent metal salts of the general formula (I) to (III).

In a further embodiment, at least one surface postcrosslinker is added to the aqueous solution or dispersion of the at least one polyvalent metal salt of the general formula (I) to (III) before, during or after the synthesis thereof, preferably from the group of ethylene glycol, propylene glycol, 1,3-propanediol, 1,4-butanediol, glycerol, N-(2-hydroxyethyl)-2-oxazolidone, 2-oxazolidone, ethylene carbonate and propylene carbonate. With regard to the amounts for the added amounts, the restrictions regarding surface postcrosslinking as specified below apply.

The solution thus prepared is used directly or in further-diluted form. A particular advantage of this embodiment is an increased storage stability of the solutions thus prepared.

The aqueous solution of the at least one polyvalent metal salt of the general formula (I) to (III) is generally a true solution or a colloidal solution, but sometimes also a suspension.

The water-absorbing polymer particles are typically water-insoluble.

The monomers i) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers i) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers i) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers i). Suitable purification processes are described, for example, in WO 2002/055469 A1, WO 2003/078378 A1 and WO 2004/035514 A1. A suitable monomer i) is, for example, an acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers i) is preferably at least 50 mol %, more preferably at least 90 mol %, most preferably at least 95 mol %.

The monomers i) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, and preferably at least 10 ppm by weight, more preferably at least 30 ppm by weight and especially around 50 ppm by weight, of hydroquinone monoether, based in each case on the unneutralized monomer i). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers ii) are compounds having at least two groups suitable for crosslinking. Such groups are, for example, ethylenically unsaturated groups which can be polymerized free-radically into the polymer chain, and functional groups which can form covalent bonds with the acid groups of the monomer i). In addition, polyvalent metal salts which can form coordinate bonds with at least two acid groups of the monomer a) are also suitable as crosslinkers ii).

Crosslinkers ii) are preferably compounds having at least two polymerizable groups which can be polymerized free-radically into the polymer network. Suitable crosslinkers ii) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301A1 and DE 103 31 450 A1, mixed acrylates which, as well as acrylate groups, comprise further ethylenically unsaturated groups, as described in DE 103 31 456 A1 and DE 103 55 401A1, or crosslinker mixtures, as described, for example, in DE 195 43 368 A1, DE 196 46 484 A1, WO 90/15830 A1 and WO 2002/32962 A2.

Suitable crosslinkers ii) are especially N,N′-methylenebisacrylamide and N,N′-methylenebismethacrylamide, esters of unsaturated mono- or polycarboxylic acids of polyols, such as diacrylates or triacrylates, for example butanediol diacrylate, ethylene glycol diacrylate and trimethylolpropane triacrylate, and allyl compounds, such as allyl acrylate, allyl methacrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described, for example, in EP 0 343 427 A1. Further suitable crosslinkers ii) are pentaerythritol diallyl ether, pentaerythritol triallyl ether, pentaerythritol tetraallyl ether, polyethylene glycol diallyl ether, ethylene glycol diallyl ether, glyceryl di- and triallyl ether, polyallyl ethers based on sorbitol, and also ethoxylated variants thereof. In the process of the invention, it is possible to use diacrylates and dimethacrylates of polyethylene glycols, the polyethylene glycol used having a molecular weight between 300 and 1000.

However, particularly advantageous crosslinkers ii) are di- and triacrylates of 3- to 15-tuply ethoxylated glycerol, of 3- to 15-tuply ethoxylated trimethylolpropane, especially di- and triacrylates of 3-tuply ethoxylated glycerol or of trimethylolpropane, of 3-tuply propoxylated glycerol or trimethylolpropane, and also of 3-tuply mixed ethoxylated or propoxylated glycerol or trimethylolpropane, of 15- to 25-tuply ethoxylated glycerol, trimethylolethane or trimethylolpropane, and also of 40-tuply ethoxylated glycerol, trimethylolethane or trimethylolpropane.

Very particularly preferred crosslinkers ii) are the polyethoxylated and/or -propoxylated glycerols which have been esterified with acrylic acid or methacrylic acid to di- or triacrylates or di- or trimethacrylates, as described, for example, in DE 103 19 462 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual contents (typically below 10 ppm) in the water-absorbing polymer particles and the aqueous extracts of the swollen water-absorbing polymer particles produced therewith have an almost unchanged surface tension (typically at least 0.068 N/m at 23° C.) compared to water at the same temperature.

The amount of crosslinker ii) is preferably 0.05 to 2.5% by weight, more preferably 0.1 to 1% by weight, most preferably 0.3 to 0.6% by weight, based in each case on the monomer i). With rising crosslinker content, centrifuge retention capacity (CRC) falls and the absorption under a pressure of 21.0 g/cm² passes through a maximum.

Examples of ethylenically unsaturated monomers iii) which are copolymerizable with the monomers i) are acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

The water-soluble polymers iv) used may be polyvinyl alcohol, polyvinylamine, polyvinylpyrrolidone, starch, starch derivatives, modified cellulose, such as methylcellulose or hydroxyethylcellulose, gelatin, polyglycols, such as polyethylene glycols, or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. monomer solutions with excess monomer i), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution or suspension can therefore be freed of dissolved oxygen before the polymerization by inertization, i.e. flowing an inert gas through, preferably nitrogen or carbon dioxide. The oxygen content of the monomer solution or suspension is preferably lowered before the polymerization to less than 1 ppm by weight, more preferably to less than 0.5 ppm by weight, most preferably to less than 0.1 ppm by weight.

For better control of the polymerization reaction, it is optionally possible to add all known chelating agents to the monomer solution or suspension or to the raw materials thereof. Suitable chelating agents are, for example, phosphoric acid, diphosphoric acid, triphosphoric acid, polyphosphoric acid, citric acid, tartaric acid, or salts thereof.

Further suitable examples are iminodiacetic acid, hydroxyethyliminodiacetic acid, nitrilotriacetic acid, nitrilotripropionic acid, ethylenediaminetetraacetic acid, diethylenetriaminepentaacetic acid, triethylenetetraaminehexaacetic acid, N,N-bis(2-hydroxyethyl)glycine and trans-1,2-diaminocyclohexanetetraacetic acid, and salts thereof. The amount used is typically 1 to 30 000 ppm based on the monomers i), preferably 10 to 1000 ppm, preferentially 20 to 600 ppm, more preferably 50 to 400 ppm, most preferably 100 to 300 ppm.

The preparation of a suitable base polymer and further suitable monomers i) are described, for example, in DE 199 41 423 A1, EP 0 686 650 A1, WO 2001/45758 A1 and WO 2003/104300 A1.

The reaction is preferably performed in a kneader, as described in WO 2001/038402 A1, or on a belt reactor, as described in EP 0 955 086 A1. Also advantageous, however, are production by the process of inverse suspension polymerization or of droplet polymerization. In both processes, rounded base polymer particles are obtained, often even with spherical morphology. In droplet polymerization, base polymer particles are also producible, which already have relatively dense surface crosslinking of the particles as early as after the polymerization and without further surface postcrosslinking.

The morphology of the base polymer particles can be selected as desired; for example, it is possible to use irregular particles in the form of fragments with smooth surfaces, irregular particles with rough surfaces, particle aggregates, rounded particles or spherical particles.

The polymerization is advantageously brought about by thermal and/or redox initiator systems. Suitable thermal initiators are azo initiators, peroxodisulfates, peroxodiphosphates and hydroperoxides. Peroxo compounds such as hydrogen peroxide, tert-butyl hydroperoxide, ammonium persulfate, potassium persulfate and sodium persulfate are preferably also used as at least one initiator component in redox initiator systems. Peroxide can, for example, also be obtained in situ by reduction of the oxygen present by means of a mixture of glucose and glucose oxidase or by means of other enzymatic systems.

The reduction components used may, for example, be ascorbic acid, bisulfite, thiosulfate, 2-hydroxy-2-sulfonatoacetic acid, 2-hydroxy-2-sulfinatoacetic acid, or salts thereof, polyamines, for example N,N,N′,N′-tetramethylethylenediamine.

The acid groups of the resulting polymer gels have preferably been neutralized to an extent of greater than 45 mol %, more preferably to an extent of greater than 55 mol %, especially preferably to an extent of greater than 65 mol %, very especially preferably to an extent of greater than 68 mol %, and preferably to an extent of at most 80 mol %, more preferably to an extent of at most 76 mol %, especially preferably to an extent of at most 74 mol %, very especially preferably to an extent of at most 72 mol %, for which the customary neutralizing agents can be used, for example ammonia, amines, such as ethanolamine, diethanolamine, triethanolamine or dimethylaminoethanolamine, preferably alkali metal hydroxides, alkali metal oxides, alkali metal carbonates or alkali metal hydrogencarbonates and mixtures thereof, particular preference being given to sodium and potassium as alkali metals, but very particular preference being given to sodium hydroxide, sodium carbonate or sodium hydrogencarbonate, and mixtures thereof. It is optionally also possible to use water-soluble alkali metal silicates at least for partial neutralization and to increase the gel strength. Typically, neutralization is achieved by mixing in the neutralizing agent as an aqueous solution or else preferably as a solid.

The neutralization can be carried out after the polymerization, at the polymer gel stage. However, it is also possible to neutralize up to 40 mol %, preferably 10 to 30 mol %, more preferably 15 to 25 mol %, of the acid groups before the polymerization, by adding a portion of the neutralizing agent directly to the monomer solution, and only establishing the desired final degree of neutralization after the polymerization, at the polymer gel stage. The monomer solution can be neutralized by mixing in the neutralizing agent, either to a predetermined preliminary degree of neutralization with subsequent post-neutralization to the end value after or during the polymerization reaction, or the monomer solution is set directly to the final value by mixing in the neutralizing agent before the polymerization. The polymer gel can be mechanically comminuted, for example by means of an extruder, in which case the neutralizing agent can be sprayed on, scattered over or poured on and then cautiously mixed in. For this purpose, the gel material obtained can be extruded several times more for homogenization.

In the case of an excessively low degree of neutralization, in the course of the subsequent drying and during the subsequent surface postcrosslinking of the base polymer, there are unwanted thermal crosslinking effects which can greatly reduce the centrifuge retention capacity (CRC) of the water-absorbing polymer particles, up to the extent that they are unusable.

In the case of an excessively high degree of neutralization, however, there is less efficient surface postcrosslinking, which leads to a reduced saline flow conductivity (SFC) of the water-absorbing polymer particles.

An optimal result is obtained, in contrast, when the degree of neutralization of the base polymer is adjusted such that efficient surface postcrosslinking is achieved and hence a high saline flow conductivity (SFC), while at the same time neutralizing to such an extent that the polymer gel can be dried in the course of production in a standard belt dryer or other drying apparatus customary on the industrial scale, without loss of centrifuge retention capacity (CRC).

Before the drying, the polymer gel can still be mechanically processed further in order to comminute remaining lumps or to homogenize the size and structure of the gel particles. For this purpose, it is possible to use stirring, kneading, shaping, shearing and cutting tools. Excessive shear stress, however, can damage the polymer gel. In general, mild mechanical further processing leads to an improved drying outcome, since the more regular gel particles dry more homogeneously and have a lesser tendency to bubbles and lumps.

The neutralized polymer gel is then dried with a belt dryer, fluidized bed dryer, shaft dryer or roller dryer until the residual moisture content is preferably below 10% by weight, especially below 5% by weight, the residual moisture content being determined by EDANA recommended test method No. WSP 230.2-05 “Moisture Content”. Thereafter, the dried polymer gel is ground and screened, usable grinding equipment typically including roll mills, pin mills or vibrating mills, and screens with mesh sizes needed to produce the water-absorbing polymer particles being used.

Polymer particles with too small a particle size lower saline flow conductivity (SFC). The proportion of excessively small polymer particles (“fines”) should therefore be low.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very late stage, for example not until an apparatus connected downstream of the polymerization reactor, for example an extruder, the excessively small polymer particles can be incorporated into the resulting polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

Polymer particles of excessively large particle size lower the free swell rate. The proportion of excessively large polymer particles should therefore likewise be small.

The base polymers are subsequently surface postcrosslinked. Surface postcrosslinkers v) suitable for this purpose are compounds which comprise at least two groups which can form covalent bonds with the carboxylate groups of the polymers. Suitable compounds are, for example, alkoxysilyl compounds, polyaziridines, polyamines, polyamidoamines, di- or polyglycidyl compounds, as described in EP 0 083 022 A2, EP 0 543 303 A1 and EP 0 937 736 A2, polyhydric alcohols, as described in DE 33 14 019 A1, DE 35 23 617 A1 and EP 0 450 922 A2, or B-hydroxyalkylamides, as described in DE 102 04 938 A1 and U.S. Pat. No. 6,239,230. Also suitable are compounds with mixed functionality, such as glycidol, 3-ethyl-3-oxetanemethanol (trimethylolpropaneoxetane), as described in EP 1 199 327 A1, aminoethanol, diethanolamine, triethanolamine, or compounds which, after the first reaction, form a further functionality, such as ethylene oxide, propylene oxide, isobutylene oxide, aziridine, azetidine or oxetane.

In addition, DE 40 20 780 C1 describes cyclic carbonates, DE 198 07 502 A1 describes 2-oxazolidone and derivatives thereof, such as N-(2-hydroxyethyl)-2-oxazolidone, DE 198 07 992 C1 describes bis- and poly-2-oxazolidones, DE 198 54 573 A1 describes 2-oxotetrahydro-1,3-oxazine and derivatives thereof, DE 198 54 574 A1 describes N-acyl-2-oxazolidones, DE-102 04 937 A1 describes cyclic ureas, DE 103 34 584 A1 describes bicyclic amide acetals, EP 1 199 327 A2 describes oxetanes and cyclic ureas, and WO 2003/031482 A1 describes morpholine-2,3-dione and derivatives thereof, as suitable surface postcrosslinkers v).

The surface postcrosslinking is typically performed by spraying a solution of the surface postcrosslinker onto the aqueous polymer gel or the dry base polymer particles. The spray application is followed by thermal surface postcrosslinking, in which case drying may take place either before or during the surface postcrosslinking reaction.

Preferred surface postcrosslinkers v) are amide acetals or carbamic esters of the general formula (VI)

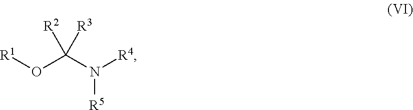

in which

R¹ is C₁-C₁₂-alkyl, C₂-C₁₂-hydroxyalkyl, C₂-C₁₂-alkenyl or C₆-C₁₂-aryl,

R² is Z or OR⁶,

R³ is hydrogen, C₁-C₁₂-alkyl, C₂-C₁₂-hydroxyalkyl, C₂-C₁₂-alkenyl or C₆-C₁₂-aryl, or Z,

R⁴ is C₁-C₁₂-alkyl, C₂-C₁₂-hydroxyalkyl, C₂-C₁₂-alkenyl or C₆-C₁₂-aryl,

R⁵ is hydrogen, C₁-C₁₂-alkyl, C₂-C₁₂-hydroxyalkyl, C₂-C₁₂-alkenyl, C₁-C₁₂-acyl or C₆-C₁₂-aryl,

R⁶ is C₁-C₁₂-alkyl, C₂-C₁₂-hydroxyalkyl, C₂-C₁₂-alkenyl or C₆-C₁₂-aryl and

Z is a carbonyl oxygen for the R² and R³ radicals together,

where R¹ and R⁴ and/or R⁵ and R⁶ may be a bridged C₂- to C₆-alkanediyl and where the abovementioned R¹ to R⁶ radicals may also have a total of from one to two free valences and may be joined to at least one suitable base structure by these free valences,

or polyhydric alcohols, the polyhydric alcohol preferably having a molecular weight of less than 100 g/mol, preferably of less than 90 g/mol, more preferably of less than 80 g/mol, most preferably of less than 70 g/mol, per hydroxyl group, and no vicinal, geminal, secondary or tertiary hydroxyl groups, and polyhydric alcohols are either diols of the general formula (VIIa)

HO—R⁷—OH (VIIa),

in which R⁷ is either an unbranched dialkyl radical of the formula —(CH₂)ₚ— where p is an integer from 2 to 20, preferably from 3 to 12, and both hydroxyl groups are terminal, or R⁷ is an unbranched, branched or cyclic dialkyl radical, or polyols of the general formula (VIIb)

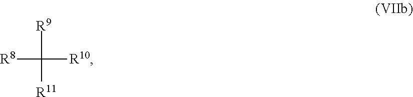

in which the R⁸, R⁹, R¹⁰, R¹¹ radicals are each independently hydrogen, hydroxyl, hydroxymethyl, hydroxyethyloxymethyl, 1-hydroxyprop-2-yloxymethyl, 2-hydroxypropyloxymethyl, methyl, ethyl, n-propyl, isopropyl, n-butyl, n-pentyl, n-hexyl, 1,2-dihydroxyethyl, 2-hydroxyethyl, 3-hydroxypropyl or 4-hydroxybutyl, and a total of 2, 3 or 4, preferably 2 or 3, hydroxyl groups are present, and not more than one of the R⁸, R⁹, R¹⁰, and R¹¹ radicals is hydroxyl,

or cyclic carbonates of the general formula (VIII)

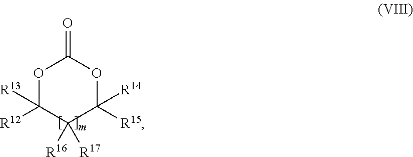

in which R¹², R¹³, R¹⁴, R¹⁵, R¹⁶ and R¹⁷ are each independently hydrogen, methyl, ethyl, n-propyl, isopropyl, n-butyl, sec-butyl or isobutyl, and m is either 0 or 1,

or bisoxazolines of the general formula (IX)

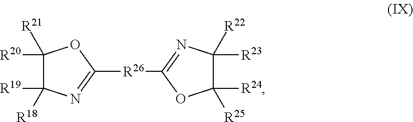

in which R¹⁸, R¹⁹, R²⁰, R²¹, R²², R²³, R²⁴ and R₂₅ are each independently hydrogen, methyl, ethyl, n-propyl, isopropyl, n-butyl, sec-butyl or isobutyl, and R²⁶ is a single bond, a linear, branched or cyclic C₁-C₁₂-dialkyl radical, or a polyalkoxydiyl radical which is formed from one to ten ethylene oxide and/or propylene oxide units, as possessed, for example, by polyglycoldicarboxylic acids.

The preferred surface postcrosslinkers v) are exceptionally selective. Side reactions and further reactions which lead to volatile and hence malodorous compounds are minimized. The water-absorbing polymer particles prepared with the preferred surface postcrosslinkers v) are therefore odor-neutral even in the moistened state.

Owing to their low reactivity, polyhydric alcohols as surface postcrosslinkers v) require high surface postcrosslinking temperatures. Alcohols which have vicinal, geminal, secondary and tertiary hydroxyl groups form by-products which are unwanted in the hygiene sector, which lead to unpleasant odors and/or discoloration of the hygiene article in question during production or use.

Preferred surface postcrosslinkers v) of the general formula (VI) are 2-oxazolidones such as 2-oxazolidone and N-hydroxyethyl-2-oxazolidone.

Preferred surface postcrosslinkers v) of the general formula (VIIa) are 1,3-propanediol, 1,4-butanediol, 1,5-pentanediol, 1,6-hexanediol and 1,7-heptanediol. Further examples of surface postcrosslinkers of the formula (VIIa) are 1,3-butanediol, 1,8-octanediol, 1,9-nonanediol and 1,10-decanediol.

The diols of the general formula (VIIa) are preferably water-soluble, these diols being water-soluble at 23° C. to an extent of at least 30% by weight, preferably to an extent of at least 40% by weight, more preferably to an extent of at least 50% by weight, most preferably at least to an extent of 60% by weight, for example 1,3-propanediol and 1,7-heptanediol. Even more preferred are those surface postcrosslinkers which are liquid at 25° C.

Preferred surface postcrosslinkers v) of the general formula (VIIb) are butane-1,2,3-triol, butane-1,2,4-triol, glycerol, trimethylolpropane, trimethylolethane, pentaerythritol, 1- to 3-tuply ethoxylated glycerol, trimethylolethane or trimethylolpropane and 1- to 3-tuply propoxylated glycerol, trimethylolethane or trimethylolpropane. Additionally preferred are 2-tuply ethoxylated or propoxylated neopentyl glycol. Particular preference is given to 2-tuply and 3-tuply ethoxylated glycerol and trimethylolpropane.

Preferred polyhydric alcohols of the general formulae (VIIa) and (VIIb) have, at 23° C., a viscosity of less than 3000 mPas, preferably less than 1500 mPas, more preferably less than 1000 mPas, especially preferably less than 500 mPas, very especially preferably less than 300 mPas.

Particularly preferred surface postcrosslinkers v) of the general formula (VIII) are ethylene carbonate and propylene carbonate.

A particularly preferred surface postcrosslinker v) of the general formula (VIII) is 2,2′-bis(2-oxazoline).

The at least one surface postcrosslinker v) is typically used in an amount of at most 0.3% by weight, preferably of at most 0.15% by weight, more preferably of 0.001 to 0.095% by weight, based in each case on the base polymer, as an aqueous solution.

It is possible to use a single surface postcrosslinker v) from the above selection, or any desired mixtures of different surface postcrosslinkers.

The aqueous surface postcrosslinker solution may, as well as the at least one surface postcrosslinker v), typically also comprise a cosolvent.

Cosolvents of good suitability for technical purposes are C₁- to C₆-alcohols, such as methanol, ethanol, n-propanol, isopropanol, n-butanol, sec-butanol, tert-butanol or 2-methyl-1-propanol, C₂- to C₅-diols, such as ethylene glycol, propylene glycol or 1,4-butanediol, ketones such as acetone, or carboxylic esters such as ethyl acetate. A disadvantage of many of these cosolvents is that they have typical intrinsic odors.

The cosolvent itself is ideally not a surface postcrosslinker under the reaction conditions. However, in the limiting case and depending on residence time and temperature, the cosolvent may partly contribute to surface postcrosslinking. This is the case especially when the surface postcrosslinker v) is relatively slow to react and can therefore also constitute its own cosolvent, as is the case, for example, when cyclic carbonates of the general formula (VIII), diols of the general formula (VIIa) or polyols of the general formula (VIIb) are used. Such surface postcrosslinkers v) can also be used in the function as a cosolvent in a mixture with more reactive surface postcrosslinkers v), since the actual surface postcrosslinking reaction can then be performed at lower temperatures and/or with shorter residence times than in the absence of the more reactive surface postcrosslinker v). Since the cosolvent is used in relatively large amounts and some also remains in the product, it must not be toxic.

In the process according to the invention, the diols of the general formula (VIIa), the polyols of the general formula (VIIb) and the cyclic carbonates of the general formula (VIII) are also suitable as cosolvents. They fulfill this function in the presence of a reactive surface postcrosslinker v) of the general formula (VI) and/or (IX), and/or of a di- or triglycidyl crosslinker. Preferred cosolvents in the process according to the invention are, however, especially diols of the general formula (VIIa).

Further cosolvents which are particularly preferred in the process according to the invention are the polyols of the general formula (VIIb). Especially preferred among these are the 2- to 3-tuply alkoxylated polyols. Particularly suitable cosolvents are also 3- to 15-tuply, very particularly 5- to 10-tuply, ethoxylated polyols based on glycerol, trimethylolpropane, trimethylolethane or pentaerythritol. Particularly suitable is 7-tuply ethoxylated trimethylolpropane.

Particularly preferred combinations of low-reactivity surface postcrosslinker v) as a cosolvent and reactive surface postcrosslinker v) are combinations of preferred polyhydric alcohols, diols of the general formula (VIIa) and polyols of the general formula (VIIb), with amide acetals or carbamic esters of the general formula (VI).

Very particularly preferred combinations are 2-oxazolidone/1,3-propanediol, 2-oxazolidone/propylene glycol, N-(2-hydroxyethyl)-2-oxazolidone/1,3-propanediol and N-(2-hydroxyethyl)-2-oxazolidone/propylene glycol.

Further preferred combinations are propylene glycol/1,4-butanediol, propylene glycol/1,3-propanediol, 1,3-propanediol/1,4-butanediol, dissolved in water and/or isopropanol as a nonreactive solvent.

Further preferred surface postcrosslinker mixtures are ethylene carbonate/water and 1,3-propanediol/water. These can optionally be used in a mixture with isopropanol.

Frequently, the concentration of the cosolvent in the aqueous surface postcrosslinker solution is from 15 to 50% by weight, preferably from 15 to 40% by weight, more preferably from 20 to 35% by weight, based on the solution. In the case of cosolvents which have only limited miscibility with water, the aqueous surface postcrosslinker solution will advantageously be adjusted such that only one phase is present, optionally by lowering the concentration of the cosolvent.

In a preferred embodiment, no cosolvent is used. The at least one surface postcrosslinker v) is then employed only as a solution in water, optionally with addition of a deagglomeration assistant.

The concentration of the at least one surface postcrosslinker v) in the aqueous solution is, for example, 1 to 20% by weight, preferably 1.5 to 10% by weight, more preferably 2 to 5% by weight, based on the solution.

The total amount of the surface postcrosslinker solution based on base polymer is typically from 0.3 to 15% by weight, preferably from 2 to 6% by weight.

In a preferred embodiment, a surfactant is added as a deagglomeration assistant to the base polymer, for example sorbitan monoesters such as sorbitan monococoate and sorbitan monolaurate, or ethoxylated variants thereof. Further very suitable deagglomeration assistants are the ethoxylated and alkoxylated derivatives of 2-propylheptanol, which are sold under the Lutensol XL® and Lutensol XP® brand names (BASF SE, Ludwigshafen, Germany). The deagglomeration assistant can be metered in separately or added to the surface postcrosslinker solution. The deagglomeration assistant is preferably added to the surface postcrosslinker solution.

The amount of the deagglomeration assistant used, based on base polymer, is, for example, up to 0.01% by weight, preferably up to 0.005% by weight, more preferably up to 0.002% by weight. The deagglomeration assistant is preferably metered in such that the surface tension of an aqueous extract of the swollen base polymer and/or of the swollen surface postcrosslinked water-absorbing polymer particles at 23° C. is typically at least 0.05 N/m, preferably at least 0.055 N/m, more preferably at least 0.06 N/m, especially preferably at least 0.065 N/m, very especially preferably 0.068 N/m.

In the process according to the invention, the base polymer is coated with at least one polyvalent metal salt of the general formula (I) on the particle surface. The amount of the at least one polyvalent metal cation used is preferably 0.001 to 0.5% by weight, more preferably 0.005 to 0.2% by weight, most preferably 0.02 to 0.1% by weight, based on the base polymer used. The corresponding amount of polyvalent metal salt used is greater, since the weight of the anions also has to be taken into account here.

The at least one polyvalent metal salt of the general formula (I) can be sprayed on as an aqueous solution before, during, together with or after the application of the surface postcrosslinker solution. It can also be applied after completion of the thermal surface postcrosslinking.

Preference is given, however, to application during the application of the surface postcrosslinker solution from at least two parallel nozzles. Most preferred is application together with the surface postcrosslinker solution from a combined solution of the surface postcrosslinker and of the at least one polyvalent metal salt. For this purpose, it is possible to use one or more nozzles to spray on the solution.

The base polymer used in the process according to the invention typically has a residual moisture content after the drying and before application of the surface postcrosslinker solution of less than 10% by weight, preferably less than 5% by weight. Optionally, this moisture content can also be increased to up to 75% by weight, for example by applying water in an upstream spray mixer. The moisture content is determined by EDANA recommended test method No. WSP 230.2-05 “Moisture Content”. Such an increase in the moisture content leads to slight preliminary swelling of the base polymer and improves the distribution of the surface postcrosslinker on the surface, and the penetration of the particles.

The spray nozzles usable in the process according to the invention are not subject to any restriction. The liquid to be sprayed can be supplied under pressure to such nozzles. The distribution of the liquid to be sprayed can be effected by expanding it in the nozzle bore on attainment of a particular minimum velocity. In addition, it is also possible to use one-substance nozzles for the inventive purpose, for example slit nozzles or swirl chambers (full-cone nozzles) (for example from Diisen-Schlick GmbH, Germany, or from Spraying Systems Deutschland GmbH, Germany). Such nozzles are also described in EP 0 534 228 A1 and EP 1 191 051A1.

The spraying is followed by thermal surface postcrosslinking, in which case drying can take place before, during or after the surface postcrosslinking reaction.

The spray application of the surface postcrosslinker solution is preferably performed in mixers with moving mixing tools, such as screw mixers, paddle mixers, disk mixers and plowshare mixers. Particular preference is given to vertical mixers, very particular preference to plowshare mixers and paddle mixers. Suitable mixers are, for example, Lodige® mixers, Bepex® mixers, Nauta® mixers, Processall® mixers and Schugi® mixers.

The thermal surface postcrosslinking is preferably performed in contact dryers, more preferably paddle dryers, most preferably disk dryers. Suitable dryers are, for example, Bepex® dryers and Nara® dryers. Moreover, it is also possible to use fluidized bed dryers.

The thermal surface postcrosslinking can be effected in the mixer itself, by heating the jacket or blowing in hot air Likewise suitable is a downstream dryer, for example a staged dryer, a rotary tube furnace or a heatable screw.

Particular preference is given to applying the surface postcrosslinker solution to the base polymer in a high-speed mixer, for example of the Schugi-Flexomix® or Turbolizer® type, and to thermally surface postcrosslinking it in a reaction dryer, for example of the Nara-Paddle-Dryer® type, or a disk dryer. The base polymer used may still have a temperature of 10 to 120° C. from preceding process steps; the surface postcrosslinker solution may have a temperature of 0 to 150° C. More particularly, the surface postcrosslinker solution can be heated to reduce the viscosity. For the surface postcrosslinking and drying, preference is given to the temperature range from 30 to 220° C., especially 140 to 210° C., more preferably 160 to 190° C. The preferred residence time at this temperature in the reaction mixer or dryer is below 120 minutes, more preferably below 80 minutes, especially preferably below 50 minutes, most preferably below 30 minutes.

The surface postcrosslinking dryer is purged with air or an inert gas during the drying and surface postcrosslinking reaction, in order to remove the vapors. To promote drying, the dryer and the attached equipment are very substantially heated.

It will be appreciated that cosolvents removed with the vapors can be condensed again outside the reaction dryer and optionally separated by distillation and recycled.

In a preferred embodiment, the surface postcrosslinking reaction and the drying are performed in the absence of oxidizing gases, especially oxygen, the proportion of oxidizing gas in the atmosphere which blankets the water-absorbing polymer particles being less than 10% by volume, preferably less than 1% by volume, more preferably less than 0.1% by volume, especially preferably less than 0.01% by volume, very especially preferably less than 0.001% by volume.

On completion of the reaction drying, the dried water-absorbing polymer particles are cooled. For this purpose, the hot and dry polymer particles are preferably transferred in continuous operation into a downstream cooler. This may, for example, be a disk cooler, a paddle cooler, a fluidized bed cooler or a screw cooler. Cooling is effected via the walls and optionally the stirrer units of the cooler, through which a suitable cooling medium, for example hot or cold water, flows. Appropriately, water or aqueous solutions of additives can be sprayed on in the cooler; this increases the efficiency of the cooling (partial water vaporization), and the residual moisture content in the finished product can be set to up to 6% by weight, preferably 0.01 to 4% by weight, more preferably 0.1 to 3% by weight. The increased residual moisture content reduces the dust content of the product.

Suitable additives are, for example, fumed silicas and surfactants, which prevent the caking of the polymer particles on addition of water. Optionally, it is also possible here to apply an aqueous solution of the at least one polyvalent metal salt.

Further particularly suitable additives are color-stabilizing additives, for example sodium bisulfite, sodium hypophosphite, phosphate salts, 2-hydroxy-2-sulfonatoacetic acid or salts thereof, 2-hydroxy-2-sulfinatoacetic acid or salts thereof, 1-hydroxyethylidene-1,1-diphosphonic acid or salts thereof, glyoxylic acid or salts thereof, especially the calcium and strontium salts.

Optionally, however, it is also possible merely to cool in the cooler, and to carry out the addition of water and additives in a downstream separate mixer. The cooling stops the reaction by virtue of the temperature going below the reaction temperature, and the temperature need be lowered overall only to such an extent that the product can be packaged without any problem into plastic sacks or into silo trucks.

The water-absorbing polymer particles can optionally be additionally coated with water-insoluble metal phosphates, as described in WO 2002/060983 A1.

For this purpose, the water-insoluble metal phosphates can be added as a powder or as a dispersion in a suitable dispersant, for example water.

When the water-insoluble metal phosphates are used and sprayed on in the form of dispersions, they are preferably used as aqueous dispersions, and preference is given to additionally applying an antidusting agent to fix the additive on the surface of the water-absorbing polymer particles. The antidusting agent and the dispersion are preferably applied together with the surface postcrosslinking solution, and can be applied from a combined solution or from several separate solutions via separate nozzle systems, at the same time or offset in time. Preferred antidusting agents are dendritic polymers, highly branched polymers such as polyglycerols, polyethylene glycols, polypropylene glycols, random or block copolymers of ethylene oxide and propylene oxide. Further antidusting agents suitable for this purpose are the polyethoxylates or polypropoxylates of polyhydroxyl compounds, such as glycerol, sorbitol, trimethylolpropane, trimethylolethane and pentaerythritol. Examples thereof are 1- to 100-tuply ethoxylated trimethylolpropane or glycerol. Further examples are block copolymers, such as trimethylolpropane or glycerol with a total of 1- to 40-tuple ethoxylation and then 1- to 40-tuple propoxylation. The sequence of the blocks may also be reversed.

The water-insoluble metal phosphates have a mean particle size of typically less than 400 μm, preferably less than 100 μm, more preferably less than 50 μm, especially preferably of less than 10 μm; the particle size range is most preferably from 2 to 7 μm.

However, it is also possible to actually obtain the water-insoluble metal phosphates on the surface of the water-absorbing polymer particles. For this purpose, solutions of phosphoric acid or soluble phosphates and solutions of soluble metal salts are sprayed on separately to form the water-insoluble metal phospate which is deposited on the particle surface.

The coating with the water-insoluble metal phosphate can be performed before, during or after the surface postcrosslinking. Preferred water-insoluble metal phosphates are those of calcium, strontium, aluminum, magnesium, zinc and iron.

Optionally, it is possible to additionally apply all known coatings, such as film-forming polymers, dendrimers, polycationic polymers (such as polyvinylamine, polyethyleneimine or polyallylamine), water-insoluble polyvalent metal salts, such as calcium sulfate, or hydrophilic inorganic particles, such as clay minerals, fumed silica, aluminum oxide and magnesium oxide. This can achieve additional effects, for example a reduced caking tendency, improved processing properties or a further enhancement in saline flow conductivity (SFC). When the additives are used and sprayed on in the form of dispersions, they are preferably used as aqueous dispersions, and an antidusting agent is preferably additionally applied to fix the additive on the surface of the water-absorbing polymer particles.

By the process according to the invention, water-absorbing polymer particles with high liquid conductivity, high absorption capacity and high absorption capacity under pressure are obtainable in a simple manner.

The present invention further provides hygiene articles comprising inventive water-absorbing polymer particles, preferably ultrathin diapers, comprising an absorbent core consisting of 50 to 100% by weight, preferably 60 to 100% by weight, more preferably 70 to 100% by weight, especially preferably 80 to 100% by weight, very especially preferably 90 to 100% by weight, of inventive water-absorbing polymer particles, of course not including the envelope of the absorbent core.

Very particularly advantageously, the inventive water-absorbing polymer particles are also suitable for production of laminates and composite structures, as described, for example, in US 2003/0181115 and US 2004/0019342. In addition to the hot melt adhesives described in both documents for production of such novel absorbent structures, and especially the fibers, described in US 2003/0181115, composed of hot melt adhesives to which the water-absorbing polymer particles are bound, the inventive water-absorbing polymer particles are also suitable for production of entirely analogous structures using UV-crosslinkable hot melt adhesives, which are sold, for example, as AC-Resin® (BASF SE, Ludwigshafen, Germany). These UV-crosslinkable hot melt adhesives have the advantage of already being processable at 120 to 140° C.; they therefore have better compatibility with many thermoplastic substrates. A further significant advantage is that UV-crosslinkable hot melt adhesives are very safe in toxicological terms and also do not cause any evaporation in the hygiene articles. A very significant advantage in connection with the inventive water-absorbing polymer particles is the property of the UV-crosslinkable hot melt adhesives of not tending to yellow during processing and crosslinking. This is especially advantageous when ultrathin or partly transparent hygiene articles are to be produced. The combination of the inventive water-absorbing polymer particles with UV-crosslinkable hot melt adhesives is therefore particularly advantageous. Suitable UV-crosslinkable hot melt adhesives are described, for example, in EP 0 377 199 A1, EP 0 445 641 A1, U.S. Pat. No. 5,026,806, EP 0 655 465 A1 and EP 0 377 191A1.

Cellulose-free hygiene articles are secured to suitable nonwoven backings by fixing water-absorbing polymer particles by means of thermoplastic polymers, especially of hot melt adhesives, when these thermoplastic polymers are spun to fine fibers. Such products are described in US 2004/0167486, US 2004/0071363, US 2005/0097025, US 2007/0156108, US 2008/0125735, EP 1 917 940 A2, EP 1 913 912 A1, EP 1 913 913 A2, EP 1 913 914 A1, EP 1 911 425 A2, EP 1 911 426 A2, EP 1 447 067 A1, EP 1 813 237 A2, EP 1 813 236 A2, EP 1 808 152 A2 and EP 1 447 066 A1. The production processes are described in WO 2008/155722 A2, WO 2008/155702 A1, WO 2008/155711A1, WO 2008/155710 A1, WO 2008/155701A2, WO 2008/155699 A1. Additionally known are extensible cellulose-free hygiene articles, and US 2006/0004336, US 2007/0135785, US 2005/0137085 disclose the production thereof by simultaneous fiber spinning of suitable thermoplastic polymers and incorporation of pulverulent water-absorbing polymer particles.

The water-absorbing polymer particles of the present invention are further very useful for the hygiene articles described in U.S. Pat. No. 6,972,011 and WO 2011/084981A1, the liquid storage components thereof, and the associated production processes.

The water-absorbing polymer particles are tested by the test methods described hereinafter.

### Methods

The measurements should, unless stated otherwise, be carried out at an ambient temperature of 23±2° C. and a relative air humidity of 50±10%. The water-absorbing polymer particles are mixed thoroughly before the measurement.

### Centrifuge Retention Capacity

The centrifuge retention capacity (CRC) is determined by EDANA recommended test method No. WSP 241.2-05 “Centrifuge Retention Capacity”, except that for each example the actual sample with the particle size distribution specified there is analyzed.

Absorption Under a Pressure of 21.0 g/cm² (Absorbency Under Pressure)

The absorption under a pressure of 21.0 g/cm² (AUL0.3 psi) is determined analogously to EDANA recommended test method No. WSP 242.2-05 “Absorption under Pressure”, except that a pressure of 49.2 g/cm² (AUL0.7 psi) is established instead of a pressure of 21.0 g/cm² (AUL0.3 psi) and for each example the actual sample with the particle size distribution specified there is analyzed.

Absorption Under a Pressure of 49.2 g/cm² (Absorbency Under Pressure)

The absorption under a pressure of 49.2 g/cm² (AUL0.7 psi) is determined analogously to EDANA recommended test method No. WSP 242.2-05 “Absorption under Pressure”, except that a pressure of 49.2 g/cm² (AUL0.7 psi) is established instead of a pressure of 21.0 g/cm² (AUL0.3 psi) and for each example the actual sample with the particle size distribution specified there is analyzed.

Absorption Under a Pressure of 0.0 g/cm² (Absorbency Under Pressure)

The absorption under a pressure of 0.0 g/cm² (AUL0.0psi) is determined analogously to EDANA recommended test method No. WSP 242.2-05 “Absorption Under Pressure”, except that a pressure of 0.0 g/cm² (AUL0.0psi) is established instead of a pressure of 21.0 g/cm² (AUL0.3 psi) and, for each example, the actual sample is measured with the particle size distribution specified therefor. The measurement is conducted here with omission of any weight on the sample, such that the sample is stressed only by its own weight in the course of swelling.

### Saline Flow Conductivity

The saline flow conductivity (SFC) of a swollen gel layer under a pressure of 0.3 psi (2070 Pa) is, as described in EP 0 640 330 A1, determined as the gel layer permeability of a swollen gel layer of water-absorbing polymer particles, the apparatus described on page 19 and in FIG. 8 in the aforementioned patent application having been modified such that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC[cm³s/g]=(Fg(t=0)×L0)/(dxAxWP)

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### Gel Bed Permeability

The gel bed permeability (GBP) of a swollen gel layer under a pressure of 0.3 psi (2070 Pa) is, as described in US 2005/0256757 (paragraphs [0061] and [0075]), determined as gel bed permeability of a swollen gel layer of water-absorbing polymer particles.

### Extractables 16 h

The content of extractable constituents of the water-absorbing polymer particles is determined by EDANA recommended test method No. WSP 270.2-05 “Extractables”.

### Free Swell Rate

To determine the free swell rate (FSR), 1.00 g (=W1) of water-absorbing polymer particles are weighed into a 25 ml beaker and distributed homogeneously over the base thereof. Then 20 ml of a 0.9% by weight sodium chloride solution are metered into a second beaker by means of a dispenser and the contents of this beaker are added rapidly to the first, and a stopwatch is started. As soon as the last drop of the sodium chloride solution has been absorbed, which is evident by the disappearance of the reflection on the liquid surface, the stopwatch is stopped. The exact amount of liquid which has been poured out of the second beaker and absorbed by the polymer in the first beaker is determined accurately by reweighing the second beaker (=W2). The time required for the absorption, which was measured with the stopwatch, is designated as t. The disappearance of the last liquid drop on the surface is determined as the time t.

The free swell rate (FSR) is calculated therefrom as follows:

FSR[g/gs]=W2/(W1xt)

When the moisture content of the water-absorbing polymer particles, however, is more than 3% by weight, the weight W1 has to be corrected by this moisture content.

### Surface Tension of the Aqueous Extract

0.50 g of the water-absorbing polymer particles is weighed into a small beaker, and 40 ml of a 0.9% by weight salt solution are added. The contents of the beaker are stirred at 500 rpm with a magnetic stirrer bar for 3 minutes, then left to stand for 2 minutes. Finally, the surface tension of the supernatant aqueous phase is measured with a K10-ST digital tensiometer (Kruss GmbH; Hamburg; Germany) or comparable instrument with a platinum plate. The measurement is performed at a temperature of 23° C.

### Wicking Test

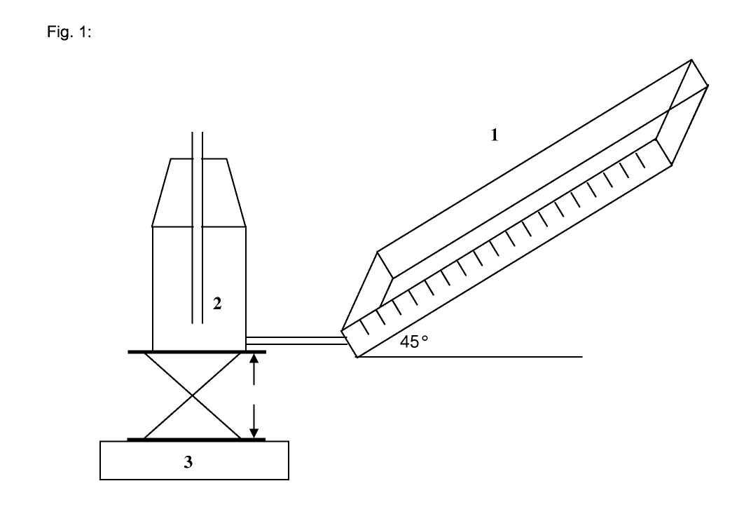

The wicking test is used to determine the wicking properties of the water-absorbing composite material. The test apparatus is depicted in FIG. 1. For this, the water-absorbing composite material is placed into a flat-bottomed pan (1) tilted by 45° relative to the horizontal. A centimeter scale is attached on the side of the pan (1) to determine wicking length. The pan (1) is connected via a flexible tube to a height-adjustable stock reservoir vessel (2). The stock reservoir vessel (2) contains 0.9% of weight NaCl solution additionally colored red with 0.05% by weight of the food colorant E-124 and sits on a scale (3). The liquid level is adjusted such that 1 cm of the water-absorbing composite material is immersed.

What is measured is the distance which the liquid climbs within an hour in the water-absorbing composite material (wicking length) and also the amount of liquid taken up by the composite material within an hour (wicking amount).

### Rewet Under Load/Acquisition Time

A circularly round weight of 3600 g is placed in the center of the water-absorbing composite material. The weight has a diameter of 10 cm. A feed tube having an internal diameter of 10 mm is passed through the center of the weight.

The feed tube is used to add 40 ml of a 0.9% by weight NaCl solution additionally colored with the disodium salt of fluorescein. The time is taken for the liquid to be sucked up (1st acquisition time). 10 minutes after adding the liquid, the weight and the feed tube are removed. Then, 10 sheets of filter paper (Whatman® No. 1) are placed on the composite and loaded with a weight of 2500 g. The filter papers have a diameter of 9 cm and the weight has a diameter of 8 cm. After 2 minutes, the weight increase of the filter papers is determined (1st rewet under load).

The addition of 0.9% by weight NaCl solution is completed two more times to determine the weight increase by re-wetting with 20 sheets (2nd rewet under load) and 30 sheets (3rd rewet under load) of filter paper respectively.

The EDANA test methods are, for example, obtainable from the European Disposables and Nonwovens Association, Avenue Eugene Plasky 157, B-1030 Brussels, Belgium.

### EXAMPLES

### Preparation of the Base Polymer

### Example 1

A base polymer was prepared by the continuous kneader process described in WO 01/38402 A1, in a List ORP 250 Contikneter reactor (LIST AG, Arisdorf, Switzerland). For this purpose, acrylic acid was neutralized continuously with sodium hydroxide solution and diluted with water, such that the degree of neutralization of the acrylic acid was 69 mol % and the solids content (=sodium acrylate and acrylic acid) of this solution was approx. 40.0% by weight. The crosslinker used was triacrylated glycerol with a total of 3-tuple ethoxylation (Gly-3 EO-TA), which had been prepared according to US 2005/176910, and was used in an amount of 0.348% by weight based on acrylic acid monomer. The crosslinker was added continuously to the monomer stream. For the calculation of the acrylic acid monomer content, the sodium acrylate present was considered theoretically as acrylic acid. The initiation was effected by likewise continuous addition of aqueous solutions of the initiators sodium persulfate (0.11% by weight based on acrylic acid monomer), hydrogen peroxide (0.002% by weight based on acrylic acid monomer) and ascorbic acid (0.001% by weight based on acrylic acid monomer).

The polymer gel obtained was dried on a belt dryer, then the dryer cake was crushed, ground by means of a roll mill and finally screened off to a particle size of 150 to 850 μm.

The base polymer thus prepared had the following properties:

CRC=36.0 g/g

Extractables (16 h)=14.0% by weight

Particle Size Distribution

| | | | |
|---|---|---|---|
| >850 | μm | <0.1% | by wt. |
| 600-850 | μm | 29.8% | by wt. |
| 300-600 | μm | 58.1% | by wt. |
| 150-300 | μm | 11.9% | by wt. |
| <150 | μm | <0.3% | by wt. |

### Example 2

A further base polymer was prepared by the continuous kneader process described in WO 2001/38402 A1. For this purpose, acrylic acid was neutralized continuously with sodium hydroxide solution and diluted with water, such that the degree of neutralization of the acrylic acid was 72 mol % and the solids content (=sodium acrylate and acrylic acid) of this solution was approx. 38.8% by weight. The crosslinker used was Gly-3EO-TA in an amount of 0.484% by weight based on acrylic acid monomer. The crosslinker was added continuously to the monomer stream. The initiation was effected by likewise continuous addition of aqueous solutions of the initiators sodium persulfate (0.14% by weight based on acrylic acid monomer), hydrogen peroxide (0.001% by weight based on acrylic acid monomer) and ascorbic acid (0.002% by weight based on acrylic acid monomer).

The resulting polymer gel was dried on a belt dryer, then the dryer cake was crushed, ground on a roll mill and finally screened off to a particle size of 150 to 850 μm.

The base polymer thus prepared had the following properties:
CRC=33.6 g/g
Extractables (16 h)=12.2% by weight

Particle Size Distribution

| | | | |
|---|---|---|---|
| >850 | μm | 0.02% | by wt. |
| 600-850 | μm | 26.1% | by wt. |
| 300-600 | μm | 48.3% | by wt. |
| 150-300 | μm | 24.9% | by wt. |
| <150 | μm | <0.1% | by wt. |

### Example 3

An acrylic acid/sodium acrylate solution was prepared by continuous mixing of deionized water, 50% by weight aqueous sodium hydroxide solution and acrylic acid, so that the degree of neutralization was 71 mol %. The solids content of the monomer solution was 40% by weight.

The polyethylenically unsaturated crosslinker used was 3-tuply ethoxylated glycerol triacrylate (about 85% by weight solution in acrylic acid). The amount used was 1.5 kg of crosslinker per metric ton (t) of monomer solution.

The free-radical polymerization was initiated using, per t of monomer solution, 1 kg of a 0.25% by weight aqueous hydrogen peroxide solution, 1.5 kg of a 30% by weight aqueous sodium peroxodisulfate solution and 1 kg of a 1% by weight aqueous ascorbic acid solution.

Monomer solution throughput was 18 t/h. The reaction solution had a temperature of 30° C. at the feed point.

The individual components were continuously metered into a List Contikneter reactor having a capacity of 6.3 m³ (LIST AG, Arisdorf, CH) in the following amounts:

| | | |
|---|---|---|
| 18 | t/h | of monomer solution |
| 27 | kg/h | of 3-tuply ethoxylated glycerol triacrylate |
| 45 | kg/h | of hydrogen peroxide solution/sodium peroxodisulfate solution |
| 18 | kg/h | of ascorbic acid |

The monomer solution was inertized with nitrogen between the feed point for the crosslinker and the feed points for the initiators.

In addition, fines generated in the manufacturing operation by grinding and sieving were metered into the reactor at 1000 kg/h after about 50% of the residence time. The residence time of the reaction mixture in the reactor was 15 minutes.

The polymer gel obtained was applied to a belt dryer. On the belt dryer, the polymer gel was continuously subjected to the flow of an air-gas mixture and dried. The residence time in the belt dryer was 37 minutes.

The dried polymer gel was ground and screened off to a particle size fraction of 150 to 850 μm.

The resulting water-absorbing polymer particles (base polymer) had the following particle size distribution:

| | | | |
|---|---|---|---|
| >800 | μm | 2.5% | by wt. |
| 300 to 600 | μm | 82.6% | by wt. |
| 200 to 300 | μm | 11.0% | by wt. |
| 100 to 200 | μm | 3.7% | by wt. |
| <100 | μm | <0.2% | by wt. |

The resulting water-absorbing polymer particles (base polymer) had a centrifuge retention capacity (CRC) of 38.7 g/g, absorbency under a load of 49.2 g/cm² (AUL0.7 psi) of 7.3 g/g and a free swell rate (FSR) of 0.27 g/gs.

### Surface Postcrosslinking of the Base Polymer

### Example 4

A Pflugschar® VT 5R-MK paddle dryer of capacity 5 l (Gebr. Lödige Maschinenbau GmbH; Paderborn, Germany) was initially charged with 1.2 kg of base polymer from example 1. Then, by means of a nitrogen-driven two-substance nozzle and while stirring, a mixture of 0.07% by weight of N-(2-hydroxyethyl)oxazolidinone, 0.07% by weight of 1,3-propanediol, 0.50% by weight of aluminum triglycolate, 0.70% by weight of propylene glycol, 1.00% by weight of isopropanol and 2.22% by weight of water, based in each case on the base polymer, was sprayed on. After the spray application, while stirring, the reactor jacket was heated by means of heating liquid, a rapid heating rate being advantageous for the product properties. The heating was controlled by a closed loop such that the product attained the target temperature of 175° C. as rapidly as possible, and was then heated there stably and while stirring. In the course of this, the reactor was blanketed with nitrogen. Samples were then taken regularly at the times reported in the table (after commencement of heating) and the properties were determined. The results are compiled in table 1.

### Example 5

### Comparative Example

The procedure was as in example 4. Instead of 0.50% by weight of aluminum triglycolate, 0.50% by weight of aluminum sulfate was used. The results are compiled in table 1.

### Example 6

The procedure was as in example 4. Instead of 1.2 kg of base polymer from example 1, 1.2 kg of base polymer from example 2 were used. The results are compiled in table 1.

TABLE 1
Surface postcrosslinking with polyvalent metal salts

| | Base | | Time | CRC | AUL0.7 psi | SFC |
|---|---|---|---|---|---|---|
| Ex. | polymer | Anion | [min] | [g/g] | [g/g] | [10⁻⁷ cm³g/s] |
| 4 | Ex. 1 | triglycolate | 20 | 32.2 | 24.0 | 23 |
| | | | 40 | 30.2 | 24.2 | 64 |
| | | | 60 | 27.7 | 24.0 | 76 |
| 5*) | Ex. 1 | sulfate | 20 | 31.9 | 20.4 | 26 |
| | | | 40 | 30.3 | 20.8 | 47 |
| | | | 60 | 29.0 | 20.2 | 63 |
| 6 | Ex. 2 | triglycolate | 20 | 29.2 | 24.0 | 37 |
| | | | 40 | 27.8 | 24.8 | 41 |
| | | | 60 | 25.0 | 23.6 | 50 |

*)Comparative example

It becomes clear from inventive examples 4 and 6 and comparative example 5 that the use of aluminum triglycolate, with comparable saline flow conductivity (SFC), always leads to a higher absorption under a pressure of 49.2 g/cm² (AUL0.7 psi). The two inventive examples 4 and 6 demonstrate that the degree of neutralization at 69 mol % (example 3) leads to a better CRC/SFC combination than a degree of neutralization of 72 mol % (example 5).

### Example 7

In a Schugi® Flexomix 100 D (Hosokawa-Micron B.V., Doetichem, the Netherlands) with gravimetric metering and continuous mass flow-controlled liquid metering via a liquid nozzle, base polymer from example 1 was sprayed with a surface postcrosslinking solution. The surface postcrosslinker solution was a mixture of 0.07% by weight of N-(2-hydroxyethyl)oxazolidinone, 0.07% by weight of 1,3-propanediol, 0.50% by weight of aluminum triglycolate, 0.70% by weight of propylene glycol, 1.00% by weight of isopropanol and 2.22% by weight of water, based in each case on the base polymer.

The moist base polymer was transferred directly from the Schugi® Flexomix falling into a NARA Paddle-Dryer® NPD 1.6 W (GMF Gouda, Waddinxveen, the Netherlands). The throughput rate of base polymer was 60 kg/h (dry), and the product temperature of the steam-heated dryer at the dryer outlet was approx. 188° C. The dryer was connected upstream of a cooler which rapidly cooled the product to approx. 50° C. The residence time in the dryer was defined via the constant throughput rate of the base polymer and the weir height of 70%, and was approx. 60 minutes. The residence time necessary is determined by preliminary tests, with the aid of which the constant metering rate which leads to the desired profile of properties is determined. This is necessary in the continuous process since the bulk density changes constantly during the reaction drying. The properties of the water-absorbing polymer particles obtained were determined. The results are compiled in table 2.

### Example 8

The procedure was as in example 7. Instead of base polymer from example 1, base polymer from example 2 was used. The results are compiled in table 2.

TABLE 2
Surface postcrosslinking with different base polymers

| | | CRC | AUL0.7 psi | SFC | FSR |
|---|---|---|---|---|---|
| Ex. | Base polymer | [g/g] | [g/g] | [10⁻⁷ cm³g/s] | [g/gs] |
| 7 | Ex. 1 | 27.3 | 23.9 | 75 | 0.13 |
| 8 | Ex. 2 | 28.6 | 23.5 | 35 | 0.22 |

It becomes clear from inventive examples 6 and 7 that the different degree of neutralization can enhance the saline flow conductivity (SFC) without reducing the absorption under a pressure of 49.2 g/cm² (AUL0.7 psi).

### Example 9

A Pflugschar® VT 5R-MK paddle dryer of capacity 5 l (Gebr. Lödige Maschinenbau GmbH; Paderborn, Germany) was initially charged with 1.2 kg of base polymer from example 1. Then, by means of a nitrogen-driven two-substance nozzle and while stirring, a mixture of 0.07% by weight of N-(2-hydroxyethyl)oxazolidinone, 0.07% by weight of 1,3-propanediol, 0.25% by weight of aluminum triglycolate, 0.25% by weight of aluminum sulfate, 0.70% by weight of propylene glycol, 1.00% by weight of isopropanol, 40 ppm of Span® 20, and 2.22% by weight of water, based in each case on the base polymer, was sprayed on. After the spray application, while stirring, the reactor jacket was heated by means of heating liquid, a rapid heating rate being advantageous for the product properties. The heating was controlled by a closed loop such that the product attained the target temperature of 180° C. as rapidly as possible, and was then heated there stably and while stirring. In the course of this, the reactor was blanketed with nitrogen. Samples were then taken regularly at the times reported in the table (after commencement of heating) and the properties were determined. The results are compiled in table 3.

### Example 10

The procedure was as in example 9. Instead of 0.25% by weight of aluminum triglycolate and 0.25% by weight of aluminum sulfate, 0.25% by weight of aluminum trilactate and 0.25% by weight of aluminum sulfate were used. The results are compiled in table 3.

### Example 11

The procedure was as in example 9. Instead of 0.25% by weight of aluminum triglycolate and 0.25% by weight of aluminum sulfate, 0.25% by weight of aluminum triglycolate and 0.25% by weight of aluminum lactate were used. The results are compiled in table 3.

### Example 12

The procedure was as in example 9. Instead of 0.25% by weight of aluminum triglycolate and 0.25% by weight of aluminum sulfate, 0.25% by weight of aluminum trilglycolate and 0.25% by weight of aluminum trimethanesulfonate were used. The results are compiled in table 3.

### Example 13

The procedure was as in example 9. Instead of 0.25% by weight of aluminum triglycolate and 0.25% by weight of aluminum sulfate, 0.10% by weight of aluminum triglycolate, 0.20% by weight of aluminum trilactate and 0.20% by weight of aluminum sulfate were used. The results are compiled in table 3.

### Example 14

The procedure was as in example 9. Instead of 0.25% by weight of aluminum triglycolate and 0.25% by weight of aluminum sulfate, 0.10% by weight of aluminum triglycolate, 0.20% by weight of aluminum trilactate and 0.20% by weight of aluminum trimethanesulfonate were used. The results are compiled in table 3.

### Example 15

The procedure was as in example 9. Instead of 0.25% by weight of aluminum triglycolate and 0.25% by weight of aluminum sulfate, 0.10% by weight of aluminum triglycolate, 0.15% by weight of aluminum trilactate and 0.25% by weight of aluminum sulfate were used. The results are compiled in table 3.

### Example 16

The procedure was as in example 9. Instead of 0.25% by weight of aluminum triglycolate and 0.25% by weight of aluminum sulfate, 0.10% by weight of aluminum triglycolate, 0.15% by weight of aluminum trilactate, 0.10% by weight of aluminum sulfate and 0.15% by weight of aluminum trimethanesulfonate were used. The results are compiled in table 3.

### Example 17

The procedure was as in example 9. Instead of 0.25% by weight of aluminum triglycolate and 0.25% by weight of aluminum sulfate, 0.20% by weight of aluminum triglycolate, 0.05% by weight of aluminum trilactate, 0.15% by weight of aluminum sulfate and 0.10% by weight of aluminum trimethanesulfonate were used. The results are compiled in table 3.

TABLE 3
Surface postcrosslinking with at least two polyvalent metal salts

| | | | AUL0.3 | AUL0.7 | | | |
|---|---|---|---|---|---|---|---|
| | Time | CRC | psi | psi | SFC | GBP | FSR |
| Ex. | [min] | [g/g] | [g/g] | [g/g] | [10⁻⁷ cm³g/s] | [darcies] | [g/gs] |
| 9 | 40 | 29.5 | 30.6 | 24.4 | 45 | | 0.27 |
| | 60 | 28.6 | 28.9 | 23.4 | 94 | 19 | 0.25 |
| | 80 | 26.5 | 28.2 | 22.5 | 104 | 21 | 0.21 |
| 10 | 40 | 30.1 | 29.9 | 23.6 | 62 | | 0.26 |
| | 60 | 27.4 | 29.6 | 23.4 | 90 | 36 | 0.22 |
| | 80 | 27.4 | 27.6 | 22.0 | 105 | 43 | 0.21 |
| 11 | 40 | 29.5 | 30.9 | 24.7 | 50 | | 0.20 |
| | 60 | 28.0 | 28.7 | 23.8 | 80 | 12 | 0.22 |
| | 80 | 27.7 | 28.5 | 22.7 | 97 | 13 | 0.20 |
| 12 | 40 | 30.2 | 30.0 | 23.8 | 60 | | 0.26 |
| | 60 | 28.0 | 29.3 | 23.4 | 110 | | 0.22 |
| 13 | 40 | 30.2 | 29.9 | 23.6 | 62 | | 0.26 |
| | 60 | 27.4 | 29.6 | 23.4 | 90 | 36 | 0.22 |
| | 80 | 27.4 | 27.6 | 22.5 | 112 | 43 | 0.21 |
| 14 | 40 | 30.3 | 30.0 | 23.7 | 55 | | 0.25 |
| | 60 | 27.8 | 29.6 | 23.5 | 95 | | 0.23 |
| 15 | 50 | 29.3 | 29.8 | 23.7 | 84 | | 0.25 |
| | 70 | 28.0 | 29.2 | 23.2 | 117 | | 0.21 |
| 16 | 50 | 29.6 | 29.9 | 23.5 | 84 | 30 | 0.24 |
| | 70 | 28.1 | 29.3 | 23.3 | 108 | 44 | 0.22 |
| 17 | 40 | 30.0 | 30.1 | 23.9 | 50 | | 0.27 |
| | 60 | 28.3 | 29.3 | 23.6 | 103 | | 0.24 |

The results show that the free swell rate (FSR), the saline flow conductivity (SFC) and the gel bed permeability (GBP) can be further increased by combining the polyvalent metal salts.

### Example 18

### Comparative Example

A 500 mL four-neck round-bottom flask was initially charged with 283 mmol of aluminum hydroxide. The flask was immersed into a preheated oil bath at 80° C. After 250 mL of water had been added, the mixture was slowly and continuously stirred with a stir-bar using a magnetic stir hotplate. Thereafter, 850 mmol of lactic acid were added to the mixture. A thermometer, a bubble counter and a reflux condenser were additionally fitted to the flask and the mixture was stirred at 75° C. overnight (15 h). The solution, which was about 25% by weight in strength, was subsequently cooled down and used directly without further aftertreatment.

A Pflugschar® MSRMK paddle dryer of capacity 5 l (Gebr. Lödige Maschinenbau GmbH; Paderborn, Germany) was initially charged with 1.2 kg of base polymer from example 3 and heated to 50° C. Then, by means of a nitrogen-driven two-substance nozzle and while stirring, a mixture of 0.07% by weight of N-(2-hydroxyethyl)oxazolidinone, 0.07% by weight of 1,3-propanediol, 1.50% by weight of the approximately 25% by weight aqueous aluminum trilactate solution, 0.30% by weight of propylene glycol, 1.00% by weight of isopropanol and 1.00% by weight of water, based in each case on the base polymer, was sprayed on and the mixture was stirred for a further 5 minutes (60 rpm). After the spray application, while stirring, the reactor jacket was heated by means of heating liquid. The heating was controlled by a closed loop such that the product attained the target temperature of 180° C. as rapidly as possible, and was then heated there stably and while stirring. In the course of this, the reactor was blanketed with nitrogen. Samples were then taken regularly at the times reported in the table (after commencement of heating) and the properties were determined. The results are compiled in table 4.

### Example 19

The procedure was as in example 18. Instead of an approximately 25% by weight aqueous aluminum trilactate solution, an approximately 25% by weight aqueous aluminum monoglycolate solution was used. The aluminum monoglycolate solution was prepared using 608 mmol of aluminum hydroxide and 608 mmol of glycolic acid. The results are compiled in table 4.

### Example 20

The procedure was as in example 18. Instead of an approximately 25% by weight aqueous aluminum trilactate solution, an approximately 25% by weight aqueous aluminum dihydroxymonodiglycolate solution was used. The aluminum dihydroxymonodiglycolate solution was prepared using 427 mmol of aluminum hydroxide and 427 mmol of diglycolic acid (3-oxopentanedioic acid). The results are compiled in table 4.

### Example 21

The procedure was as in example 18. Instead of an approximately 25% by weight aqueous aluminum trilactate solution, an approximately 25% by weight aqueous aluminumtris(3,6-dioxaheptanoate) solution was used. The aluminumtris(3,6-dioxaheptanoate) solution was prepared using 195 mmol of aluminum hydroxide and 586 mmol of 3,6-dioxaheptanoic acid. The results are compiled in table 4.

### Example 22

The procedure was as in example 18. Instead of an approximately 25% by weight aqueous aluminum trilactate solution, an approximately 25% by weight aqueous aluminumtris(3,6,9-trioxadecanoate) solution was used. The aluminumtris(3,6,9-trioxadecanoate) solution was prepared using 107 mmol of aluminum hydroxide and 322 mmol of 3,6,9-trioxadecanoic acid. The results are compiled in table 4.

### Example 23

The procedure was as in example 18. Instead of an approximately 25% by weight aqueous aluminum trilactate solution, an approximately 25% by weight aqueous aluminumtris(3,6,9-trioxaundecanedioate) solution was used. The aluminumtris(3,6,9-trioxaundecanedioate) solution was prepared using 87 mmol of aluminum hydroxide and 260 mmol of 3,6,9-trioxaundecanedioic acid. The results are compiled in table 4.

TABLE 4
Surface postcrosslinking with derivatives of glycolic acid

| | | Time | CRC | AUL0.7 psi | GBP |
|---|---|---|---|---|---|
| Ex. | Anion | [min] | [g/g] | [g/g] | [darcies] |
| 18*) | trilactate | 80 | 28.6 | 22.9 | 7.8 |
| | | 100 | 28.0 | 21.5 | 10.6 |
| | | 120 | 24.2 | 20.4 | 15.2 |
| 19 | monoglycolate | 80 | 29.1 | 22.7 | 10.3 |
| | | 100 | 28.5 | 20.8 | 13.8 |
| | | 120 | 28.3 | 19.8 | 16.6 |
| 20 | mono(3-oxapentanedioate) | 80 | 28.6 | 21.0 | 15.0 |
| | | 100 | 26.5 | 20.5 | 18.1 |
| | | 120 | 24.2 | 19.6 | 22.0 |
| 21 | tris(3,6-dioxaheptanoate) | 80 | 30.9 | 21.8 | 27.9 |
| | | 100 | 28.8 | 20.3 | 40.7 |
| | | 120 | 28.5 | 20.5 | 45.5 |
| 22 | tris(3,6,9-trioxadecanoate) | 80 | 28.6 | 21.7 | 15.7 |
| | | 100 | 28.5 | 20.8 | 20.0 |
| | | 120 | 26.4 | 20.1 | 27.7 |
| 23 | tris(3,6,9-trioxaundecane- | 80 | 29.9 | 22.3 | 9.3 |
| | dioate) | 100 | 27.3 | 21.3 | 12.2 |
| | | 120 | 27.2 | 20.8 | 16.4 |

*) Comparative example

### Example 24

A Pflugschar® MSRMK paddle dryer of capacity 5 l (Gebr. Lödige Maschinenbau GmbH; Paderborn, Germany) was initially charged with 1.2 kg of water-absorbing polymer particles from example 7. Then, by means of a nitrogen-driven 2-substance nozzle and while stirring (60 rpm), 2% by weight of water, based on the water-absorbing polymer particles used, were sprayed on within approximately 120 seconds and the mixture was stirred for a total of 15 minutes. This was followed by sieving through an 850 μm sieve in order to remove lumps. The properties of the water-absorbing polymer particles obtained are compiled in table 5.

### Example 25

The procedure was as in example 24. Instead of 2% by weight of water, a solution of 2% by weight of water and 0.25% by weight of aluminum sulfate, based in each case on the water-absorbing polymer particles used, was sprayed on. The results are compiled in table 5.

### Example 26

The procedure was as in example 24. Instead of 2% by weight of water, a solution of 2% by weight of water and 0.5% by weight of aluminum sulfate, based in each case on the water-absorbing polymer particles used, was sprayed on. The results are compiled in table 5.

### Example 27

The procedure was as in example 24. Instead of 2% by weight of water, a solution of 2% by weight of water, 0.075% by weight of polyethylene glycol (molar mass approx. 400 g/mol) and 0.25% by weight of aluminum sulfate, based in each case on the water-absorbing polymer particles used, was sprayed on. The results are compiled in table 5.

### Example 28

The procedure was as in example 24. Instead of 2% by weight of water, a solution of 2% by weight of water, 0.075% by weight of polyethylene glycol (molar mass approx. 400 g/mol) and 0.5% by weight of aluminum sulfate, based in each case on the water-absorbing polymer particles used, was sprayed on. The results are compiled in table 5.

TABLE 5
Surface postcrosslinking and subsequent coating with
at least two polyvalent metal salts

| | | AUL0.0 | AUL0.3 | | | |
|---|---|---|---|---|---|---|
| | CRC | psi | psi | AUL0.7 psi | SFC | GBP |
| Ex. | [g/g] | [g/g] | [g/g] | [g/g] | [10⁻⁷ cm³g/s] | [darcies] |
| 24 | 26.5 | 38.4 | 27.6 | 23.2 | 61 | 15 |
| 25 | 26.3 | 41.3 | 26.3 | 21.5 | 137 | 53 |
| 26 | 25.7 | 41.5 | 26.0 | 20.8 | 152 | 94 |
| 27 | 26.5 | 41.2 | 27.0 | 21.8 | 105 | 55 |
| 28 | 25.8 | 41.9 | 26.4 | 21.7 | 112 | 84 |

Examples 25 to 28 show that subsequent coating with at least one second polyvalent metal salt onto water-absorbing polymer particles already coated with a polyvalent metal salt in the course of surface postcrosslinking can achieve particularly good effects with regard to a rise in saline flow conductivity (SFC), in gel bed permeability (GBP) and in absorption under a pressure of 0.0 g/cm² (AUL0.0psi).

Producing the water-absorbing composite materials:

### Example 29

5.5 g of water-absorbing polymer particles from example 4 were weighed onto weighing boats in six portions of 0.917±0.001 g.

5.5 g of cellulose fluff were divided into six equal portions of 0.917±0.01 g.

A tissue was placed onto a rectangular wire mesh with a length of 17.5 cm and a width of 11 cm, the tissue projecting somewhat beyond the wire mesh. Above the wire mesh was a vertical shaft of the same dimensions. The vertical shaft narrowed by 10 cm above the wire mesh over a length of 16 cm and a width of 9.2 cm. Within this shaft, approx. 68 cm above the wire mesh, rotated a brush installed lengthways. The brush had a length of 17.5 cm and a diameter of 10 cm. The brush rotated at 13.5 revolutions per second. Below the wire mesh with the tissue, vacuum was applied.

The first portion of cellulose fluff was applied to the rotating brush from above. After 25 seconds, the first portion of water-absorbing polymer particles from example 3 was metered from above onto the rotating brush.

The metered additions of cellulose fluff and water-absorbing polymer particles were repeated twice more in total after 25 seconds each time. Subsequently, the wire mesh with the tissue was rotated horizontally by 180°.

Then the metered additions of cellulose fluff and water-absorbing polymer particles were repeated three times more in total, and the water-absorbing composite formed was pressed together by hand with a plunger having a length of 15 cm and a width of 8.5 cm, removed from the tissue and wrapped in a tissue with basis weight of 38 g/m², a length of 37 cm and a width of 24 cm. The water-absorbing composite material was then pressed by means of a platen press at 50 bar for 20 seconds.

The results of the Wicking test, the rewet under load and the acquisition time were determined and are compiled in tables 6 and 7.

### Example 30

### Comparative Example

The procedure was as in example 29. Instead of water-absorbing polymer particles from example 4, water-absorbing polymer particles from example 5 were used. The results are compiled in tables 6 and 7.

### Example 31

The procedure was as in example 29. Altogether 7.7 g of water-absorbing polymer particles from example 4 and altogether 3.3 g of cellulose fluff were used. The results are compiled in tables 6 and 7.

### Example 32

### Comparative Example

The procedure was as in example 31. Instead of water-absorbing polymer particles from example 4, water-absorbing polymer particles from example 5 were used. The results are compiled in tables 6 and 7.

### Example 33

The procedure was as in example 29. Altogether 8.8 g of water-absorbing polymer particles from example 4 and altogether 2.2 g of cellulose fluff were used. The results are compiled in tables 6 and 7.

### Example 34

### Comparative Example

The procedure was as in example 33. Instead of water-absorbing polymer particles from example 4, water-absorbing polymer particles from example 5 were used. The results are compiled in tables 6 and 7.

TABLE 6
Water-absorbing composite materials (Wicking test)

| Ex. | SAP | SAP content | Wicking length | Wicking amount |
|---|---|---|---|---|
| 29 | Ex. 4 | 50% by weight | 16.0 cm | 193 g |
| 30*) | Ex. 5 | 50% by weight | 16.0 cm | 210 g |
| 21 | Ex. 4 | 70% by weight | 14.2 cm | 173 g |
| 32*) | Ex. 5 | 70% by weight | 12.5 cm | 161 g |
| 33 | Ex. 4 | 80% by weight | 13.4 cm | 158 g |
| 34*) | Ex. 5 | 80% by weight | 10.7 cm | 151 g |

TABLE 7
Water-absorbing composite materials
(rewet under load and acquisition time)

| | | | Second | | Second | Third |
|---|---|---|---|---|---|---|
| | | SAP | rewet | Third rewet | acquisition | acquisition |
| Ex. | SAP | content | under load | under load | time | time |
| 29 | Ex. 4 | 50% | 6.3 g | 16.6 g | 235 s | 333 s |
| 30*) | Ex. 5 | 50% | 5.7 g | 14.4 g | 265 s | 400 s |
| 31 | Ex. 4 | 70% | 5.2 g | 12.4 g | 571 s | 666 s |
| 32*) | Ex. 5 | 70% | 6.7 g | 9.0 g | 1000 s | 800 s |
| 33 | Ex. 4 | 80% | 7.0 g | 10.3 g | 800 s | 800 s |
| 34*) | Ex. 5 | 80% | **) | **) | **) | **) |

*)Comparative example
**) Liquid no longer fully absorbed

The examples show that the water-absorbing polymer particles of the present invention perform particularly advantageously in hygiene articles of low cellulose or fiber content.

U.S. Provisional Patent Application No. 61/354,267, filed Jun. 14, 2010, is incorporated into the present patent application by literature reference. With regard to the above-mentioned teachings, numerous changes and deviations from the present invention are possible. It can therefore be assumed that the invention, within the scope of the appended claims, can be performed differently than the way described specifically herein.

1. A process for producing water-absorbing polymer particles by polymerizing a monomer solution or suspension comprising
i) at least one ethylenically unsaturated monomer which bears an acid group and may be at least partly neutralized,
ii) at least one crosslinker,
iii) optionally one or more ethylenically unsaturated monomer copolymerizable with the monomer mentioned under i) and
iv) optionally one or more water-soluble polymer, and drying, grinding, and classifying the resulting polymer gel, coating with
v) at least one surface postcrosslinker and thermally surface postcrosslinking it, wherein the water-absorbing polymer particles are coated before, during, or after the thermal surface postcrosslinking with at least one polyvalent metal salt of the general formula (I)
Mⁿ(X)ₐ(Y)_{c}(OH)_{d} (I)
or with at least two polyvalent metal salts of the general formula (II) and/or of the general formula (III)
Mⁿ(X)ₐ(OH)_{d} (II)
Mⁿ(Y)_{b}(OH)_{d} (III)
in which
M is a polyvalent metal cation of a metal selected from the group of aluminum, zirconium, iron, titanium, zinc, calcium, magnesium and strontium,
n is the valency of the polyvalent metal cation,
a is from 0.1 to n,
b is from 0.1 ton, and
c is from 0 to (n-0.1), and
d is from 0 to (n-0.1),
wherein in the general formula (I) the sum of a, c, and d is less than or equal to n, in the general formula (II) a and d is less than or equal to n, and in the general formula (III) b and d is less than or equal to n,
X is an acid anion of an acid selected from the group of glycolic acid, diglycolic acid, ethoxylated glycolic acids of the general formula (IV) 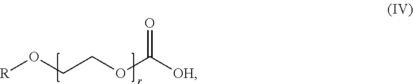
and ethoxylated diglycolic acids of the general formula (V) 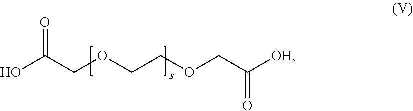
in which
R is H or C₁- to C₁₆-alkyl,
r is an integer from 1 to 30, and
s is an integer from 1 to 30,
and
Y is an acid anion of an acid selected from the group of glyceric acid, citric acid, lactic acid, lactoyllactic acid, malonic acid, hydroxymalonic acid, glycerol-1,3-diphosphoric acid, glycerolmonophosphoric acid, acetic acid, formic acid, propionic acid, methanesulfonic acid, phosphoric acid, and sulfuric acid.

2. The process according to claim 1, wherein the water-absorbing polymer particles are coated with 0.02 to 0.1% by weight of the polyvalent metal cation.

3. The process according to claim 1, wherein the polyvalent metal salt of the general formula (I), of the general formula and/or of the general formula (III) is prepared by reacting a hydroxide of the polyvalent metal cation with the acid of the acid anion.

4. The process according to claim 1, wherein the water-absorbing polymer particles are coated with an aqueous solution comprising the polyvalent metal salt of the general formula (I), of the general formula and/or of the general formula (III).

5. The process according to claim 1, wherein the metal cation of the polyvalent metal salt of the general formula (I), of the general formula and/or of the general formula (III) is a cation of aluminum.

6. The process according to claim 1, wherein the acid anion of the polyvalent metal salt of the general formula (I) is an anion of glycolic acid or the acid anions of the polyvalent metal salts of the general formula (II) and/or of the general formula (III) are an anion of lactic acid and an anion of sulfuric acid.

7. The process according to claim 1, wherein the monomer i) is acrylic acid.

8. Water-absorbing polymer particles obtainable by a process according to claim 1.

9. Water-absorbing polymer particles comprising
a) at least one polymerized ethylenically unsaturated monomer which bears an acid group and may be at least partly neutralized,
b) at least one polymerized crosslinker,
c) optionally one or more ethylenically unsaturated monomer copolymerized with the monomer mentioned under a),
d) optionally one or more water-soluble polymer, and
e) at least one reacted surface postcrosslinker,
said water-absorbing polymer particles having been coated with at least one polyvalent metal salt of the general formula (I)
Mⁿ(X)ₐ(Y)_{c}(OH)_{d} (I)
or with at least two polyvalent metal salts of the general formula (II) and/or of the general formula (III)
Mⁿ(X)ₐ(OH)_{d} (II)
Mⁿ(Y)_{b}(OH)_{d} (III)
in which
M is a polyvalent metal cation of a metal selected from the group of aluminum, zirconium, iron, titanium, zinc, calcium, magnesium, and strontium,
n is the valency of the polyvalent metal cation,
a is from 0.1 to n,
b is from 0.1 ton, and
c is from 0 to (n-0.1), and
d is from 0 to (n-0.1),
where in the general formula (I) the sum of a, c, and d is less than or equal to n, in the general formula (II) a and d is less than or equal to n, and in the general formula (III) b and d is less than or equal to n,
X is an acid anion of an acid selected from the group of glycolic acid, diglycolic acid, ethoxylated glycolic acids of the general formula (IV) 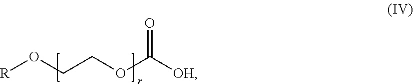
and ethoxylated diglycolic acids of the general formula (III) 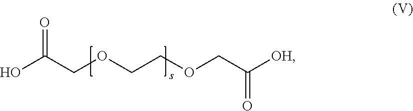
in which
R is H or C₁- to C₁₆-alkyl,
r is an integer from 1 to 30, and
s is an integer from 1 to 30,
and
Y is an acid anion of an acid selected from the group of glyceric acid, citric acid, lactic acid, lactoyllactic acid, malonic acid, hydroxymalonic acid, glycerol-1,3-diphosphoric acid, glycerolmonophosphoric acid, acetic acid, formic acid, propionic acid, methanesulfonic acid, phosphoric acid, and sulfuric acid.

10. Polymer particles according to claim 9, which have been coated with 0.02 to 0.1% by weight of the polyvalent metal cation.

11. Polymer particles according to claim 9, wherein the metal cation of the polyvalent metal salt of the general formula (I), of the general formula and/or of the general formula (III) is a cation of aluminum.

12. Polymer particles according to claim 9, wherein the carboxylic acid anion of the polyvalent metal salt of the general formula (I) is an anion of glycolic acid or the acid anions of the polyvalent metal salts of the general formula (II) and/or of the general formula (III) are an anion of lactic acid and an anion of sulfuric acid.

13. Polymer particles according to claim 9, wherein the surface tension of the aqueous extract of the swollen water-absorbing polymer particles at 23° C. is at least 0.05 N/m.

14. Polymer particles according to claim 9, which have a centrifuge retention capacity of at least 24 g/g and/or an absorption under a pressure of 49.2 g/cm² of at least 15 g/g.

15. A hygiene article comprising water-absorbing polymer particles according to claim 9.
